(19) United States
(12) Patent Application Publication
(10) Pub. No.: US 2019/0243376 A1
(43) Pub. Date: Aug. 8, 2019

(54) Actively Complementing Exposure Settings for Autonomous Navigation

(71) Applicant: QUALCOMM Incorporated, San Diego, CA (US)

(72) Inventors: Jonathan Paul DAVIS, Philadelphia, PA (US); Daniel Warren MELLINGER, III, Philadelphia, PA (US); Travis VAN SCHOYCK, Princeton, NJ (US); Charles Wheeler SWEET, III, San Diego, CA (US); John Anthony DOUGHERTY, Philadelphia, PA (US); Ross Eric KESSLER, Philadelphia, PA (US)

(21) Appl. No.: 15/888,291

(22) Filed: Feb. 5, 2018

(51) Int. Cl. G05D 1/02; H04N 5/235; H04N 5/247; G06T 7/246; G06T 7/292

(52) U.S. Cl. CPC G05D 1/0246; H04N 5/2353; H04N 5/247; H04N 5/2351; G06T 2207/30261; G06T 7/292; G05D 1/0212; G06T 2207/10144; G06T 2200/04; G06T 7/248

(57) ABSTRACT

Various embodiments include devices and methods for navigating a robotic vehicle within an environment. In various embodiments, a first image frame is captured using a first exposure setting and a second image frame is captured using a second exposure setting. A plurality of points may be identified from the first image frame and the second image frame. A first visual tracker may be assigned to a first set of the plurality of points and a second visual tracker may be assigned to a second set of the plurality of points. Navigational data may be generated based on results of the first visual tracker and the second visual tracker. The robotic vehicle may be controlled to navigate within the environment using the navigation data.

### BACKGROUND

Robotic vehicles are being developed for a wide range of applications. Robotic vehicles may be equipped with cameras capable of capturing an image, a sequence of images, or videos. Captured images may be used by the robotic vehicle to perform vision-based navigation and localization. Vision-based localization and navigation provides a flexible, extendible, and low-cost solution for navigating robotic vehicles in a variety of environments. As robotic vehicles become increasing autonomous, the ability of robotic vehicles to detect and make decisions based on environmental features becomes increasingly important. However, in situations in which the lighting of the environment varies significantly, vision-based navigation and collision avoidance may be compromised if cameras are unable to identify image features in brighter and/or darker portions of the environment.

### SUMMARY

Various embodiments include methods, and robotic vehicles with a processor implementing the methods for navigating a robotic vehicle within an environment using camera-based navigation methods that compensate for variable lighting conditions. Various embodiments may include receiving a first image frame captured using a first exposure setting, receiving a second image frame captured using a second exposure setting different from the first exposure setting, identifying a plurality of points from the first image frame and the second image frame, assigning a first visual tracker to a first set of the plurality of points identified from the first image frame and a second visual tracker to a second set of the plurality of points identified from the second image frame, generating navigation data based on results of the first visual tracker and the second visual tracker, and controlling the robotic vehicle to navigate within the environment using the navigation data.

In some embodiments, identifying the plurality of points from the first image frame and the second image frame may include identifying a plurality of points from the first image frame, identifying a plurality of points from the second image frame, ranking the plurality of points, and selecting one or more identified points for use in generating the navigation data based on the ranking of the plurality of points.

In some embodiments, generating navigation data based on the results of the first visual tracker and the second visual tracker may include tracking the first set of the plurality of points between image frames captured using the first exposure setting with the first visual tracker, tracking the second set of the plurality points between image frames captured using the second exposure setting with the second visual tracker, estimating a location of one or more of the identified plurality of points within a three-dimensional space, and generating the navigation data based on the estimated location of the one or more of the identified plurality of points within the three-dimensional space.

Some embodiments may further include using two or more cameras to capture image frames using the first exposure setting and the second exposure setting. Some embodiments may further include using a single camera to sequentially capture image frames using the first exposure setting and the second exposure setting. In some embodiments, the first exposure setting complements the second exposure setting. In some embodiments, at least one of the points identified from the first image frame is different from at least one of the points identified from the second image frame.

Some embodiments may further include determining the exposure setting for a camera used to capture the second image frame by determining whether a change in a brightness value associated with the environment exceeds a predetermined threshold, determining an environment transition type in response to determining that the change in the brightness value associated with the environment exceeds the predetermined threshold, and determining the second exposure setting based on the determined environment transition type.

In some embodiments, determining whether the change in the brightness value associated with the environment exceeds the predetermine threshold may be based on at least one of a measurement detected by an environment detection system, an image frame captured using the camera, and a measurement provided by an inertial measurement unit.

Some embodiments may further include determining a dynamic range associated with the environment, determining a brightness value within the dynamic range, determining a first exposure range for a first exposure algorithm by ignoring the brightness value, and determining a second exposure range for second exposure algorithm based on only the brightness value, in which the first exposure setting may be based on the first exposure range and the second exposure setting may be based on the second exposure range.

Various embodiments may further include a robotic vehicle having an image capture system including one or more cameras, a memory, and a processor configured with processor-executable instructions to perform operations of the methods summarized above. Various embodiments include a processing device for use in robotic vehicles that is configured to perform operations of the methods summarized above. Various embodiments include a non-transitory processor-readable medium having stored thereon processor-executable instructions configured to cause a processor of a robotic vehicle to perform functions of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a schematic diagram illustrating a robotic vehicle, a communication network, and components thereof according to various embodiments.

FIG. 2 is a component block diagram illustrating components of a control device for use in robotic vehicles according to various embodiments.

FIG. 3A is a process flow diagram illustrating a method for navigating a robotic vehicle within an environment according to various embodiments.

FIGS. 3B-3C are component flow diagrams illustrating components used in exemplary methods for navigating a robotic vehicle within an environment according to various embodiments.

FIG. 4A is a process flow diagram illustrating a method for capturing images by a robotic vehicle within an environment according to various embodiments.

FIGS. 4B-4D are exemplary image frames captured using various exposure settings according to various embodiments.

FIG. 5 is a process flow diagram illustrating another example method for capturing images by a robotic vehicle within an environment according to various embodiments.

FIG. 6 is a process flow diagram illustrating another method for determining an exposure setting according to various embodiments.

FIG. 7A is a process flow diagram illustrating another method for navigating a robotic vehicle within an environment according to various embodiments.

FIGS. 7B-7C are exemplary time and dynamic range illustrations that correspond to the method illustrated in FIG. 7A.

FIG. 8 is a component block diagram of an example robotic vehicle suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various techniques may be used to navigate a robotic vehicle (e.g., drones and autonomous vehicles) within an environment. For example, one technique for robotic vehicle navigation uses images captured by an image capture system (e.g., a system including one or more cameras) and is referred to as Visual Odometry (VO). At a high level, VO involves processing camera images to identify key points within the environment, and tracking the key points from frame-to-frame to determine the position and movement of the key points over a plurality of frames. In some embodiments, the key points may be used to identify and track distinctive pixel patches or regions within the image frame that include high contrast pixels such as a corner or a contrast point (e.g., a leaf against the sky, or a corner of a rock). The results of the key point tracking may be used in robotic vehicle navigation in various ways including, for example: object detection; generating a map of the environment; identifying objects to be avoided (i.e., collision avoidance); establishing the position, orientation and/or frame of reference of the robotic vehicle within the environment; and/or path planning for navigating within the environment. Another technique for robotic vehicle navigation is Visual Inertial Odometry (VIO), which uses images captured by one or more cameras of a robotic vehicle in combination with position, acceleration and/or orientation information associated with the robotic.

Cameras used for computer vision (CV) or machine vision (MV) applications suffer from the same technical issues as any digital camera, including implementing an exposure setting such that a useful image may be obtained. However, in CV or MV systems, capturing an image using an exposure setting that results in reduced contrast due to the resulting brightness values may prevent the system from identifying some features or objects that are either under- or over-exposed, which may undesirably affect the system implementing CV or MV.

In addition, image sensors used in digital cameras may have varying sensitives to light intensity. Various parameters of the image sensors such as material, number of pixels within the arrays, size of pixels, etc. may influence the accuracy of the image sensors within various light intensity ranges. Thus, different image sensors may be more accurate in different light intensity ranges and/or different image sensors may have capabilities to detect different light intensity ranges. For example, conventional digital cameras implementing an image sensor within an average dynamic range may result in an image including saturated highlights and shadows that undesirably reduces contrast details, which may prevent adequate object identification and/or tracking in CV or MV systems. While digital cameras implementing sensors capable of operating over a higher dynamic range may reduce saturation of highlights and shadows, such cameras may be more expensive, less rugged, and may require more frequent recalibrations than less capable digital cameras.

An exposure setting may represent a shutter speed of the camera in combination with an f-number (e.g., ratio of focal length to the diameter of the entrance pupil) of the camera. The exposure setting of a camera in a VO system can auto-adapt to brightness levels of its environment. However, because the exposure setting is a physical setting of the camera (e.g., rather than an image processing technique), individual camera systems cannot implement multiple exposure settings to capture a single image to accommodate differently illuminated areas within an environment. In most cases, a single exposure setting is sufficient for the environment. However, in some instances, significant brightness discontinuities or changes may undesirably influence how an object is captured within an image. For example, when a robotic vehicle is navigating inside a structure and the VO input camera is looking both inside where lighting is low and outside the structure where lighting is bright (or vice versa), or outside looking inside, the captured image may include features that are either under-exposed (e.g., inside features) or over-exposed (e.g., outside features) due to the exposure setting being set for either the inside or outside environment. Thus, may indoor spaces look black when the camera exposure is set for an outdoor environment, and outdoor spaces may be over-exposed when the camera exposure is set for the indoor environment. This can be problematic for robotic vehicles autonomously navigating in such conditions as the navigation processor will not have the benefit of feature location information while navigating from one to environment the other (e.g., through a doorway, into/out of a tunnel, etc.), because there could be obstacles just on the other side of the ambient light transition that the robot does not register (i.e., detect and classify), which can lead to collisions with objects that were not adequately imaged.

Various embodiments overcome shortcomings of conventional robotic vehicle navigation methods by providing methods for capturing images by an image capture system at different exposure settings to enable the detection of objects within an environment having dynamic brightness values. In some embodiments, the image capture system may include two navigation cameras configured to obtain images simultaneously at two different exposure settings, with features extracted from both images used for VO processing and navigation. In some embodiments, the image capture system may include a single navigation camera configured to obtain images alternating between two different exposure settings, with features extracted from both exposure settings used for VO processing and navigation.

As used herein, the terms “robotic vehicle” and “drone” refer to one of various types of vehicles including an onboard computing device configured to provide some autonomous or semi-autonomous capabilities. Examples of robotic vehicles include but are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors.

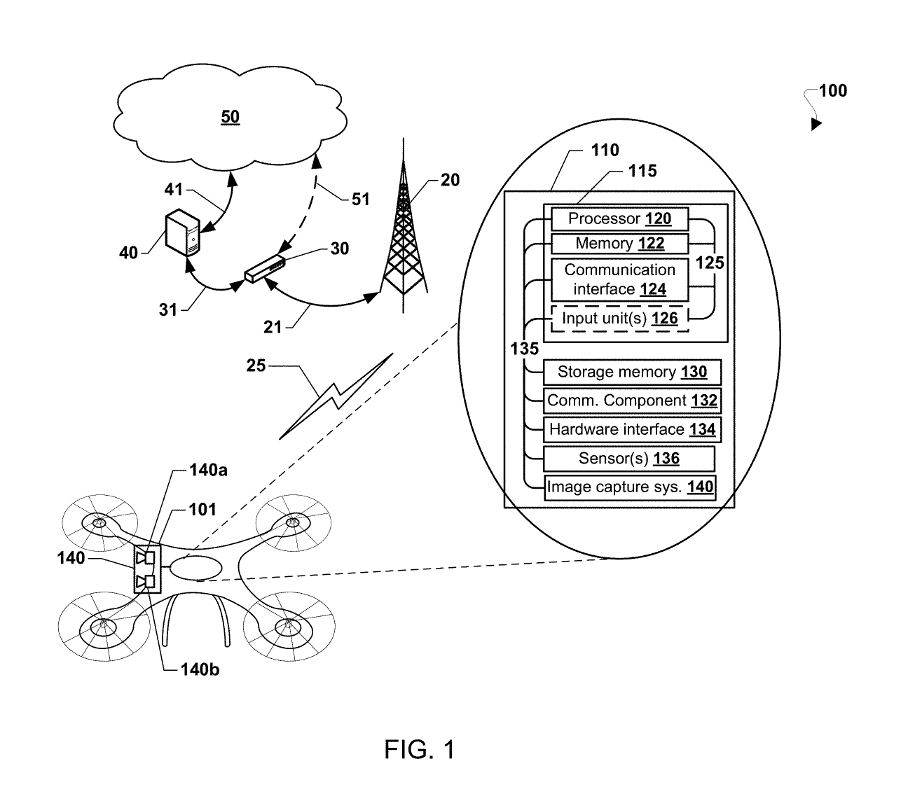

Various embodiments may be implemented within a variety of robotic vehicles, which may communicate with one or more communication networks, an example of which may be suitable for use with various embodiments is illustrated in FIG. 1. With reference to FIG. 1, a communication system 100 may include one or more robotic vehicles 101, a base station 20, one or more remote computing devices 30, one or more remote servers 40, and a communication network 50. While the robotic vehicle 101 is illustrated in FIG. 1 as being in communication with the communication network 50, robotic vehicle 101 may or may not be in communication with any communication network with respect to the navigation methods described herein.

The base station 20 may provide the wireless communication link 25, such as through wireless signals to the robotic vehicle 101. The base station 20 may include one or more wired and/or wireless communications connections 21, 31, 41, 51 to the communication network 50. While the base station 20 is illustrated in FIG. 1 as being a tower, base station 20 may be any network access node including a communication satellite, etc. The communication network 50 may in turn provide access to other remote base stations over the same or another wired and/or wireless communications connection. The remote computing device 30 may be configured to control and/or communicate with the base station 20, the robotic vehicle 101, and/or control wireless communications over a wide area network, such as providing a wireless access points and/or other similar network access point using the base station 20. In addition, the remote computing device 30 and/or the communication network 50 may provide access to a remote server 40. The robotic vehicle 101 may be configured to communicate with the remote computing device 30 and/or the remote server 40 for exchanging various types of communications and data, including location information, navigational commands, data inquiries, infotainment information, etc.

In some embodiments, the remote computing device 30 and/or the remote server 40 may be configured to communicate information to and/or receive information from the robotic vehicle 101. For example, the remote computing device 30 and/or the remote server 40 may communicate information associated with exposure setting information, navigation information, and/or information associated with the environment surrounding the robotic vehicle 101.

In various embodiments, the robotic vehicle 101 may include an image capture system 140, which may include one or more cameras 140a, 140b configured to obtain images and provide image data to a processing device 110 of the robotic vehicle 101. The term “image capture system” is used herein to refer generally to at least one camera 140a and as many as N cameras, and may include associated circuitry (e.g., one or more processors, memory, connecting cables, etc.) and structures (e.g., camera mounts, steering mechanisms, etc.). In embodiments in which two cameras 140a, 140b are included within the image capture system 140 of the robotic vehicle 101, the cameras may obtain images at different exposure settings when providing image data to the processing device 110 for VO processing as described herein. In embodiments in which only one camera 140a is included within the image capture system 140 of the robotic vehicle 101, the camera 140a may obtain images alternating between different exposure settings when providing image data to the processing device 110 for VO processing as described herein.

The robotic vehicle 101 may include a processing device 110 that may be configured to monitor and control the various functionalities, sub-systems, and/or other components of the robotic vehicle 101. For example, the processing device 110 may be configured to monitor and control various functionalities of the robotic vehicle 101, such as any combination of modules, software, instructions, circuitry, hardware, etc. related to propulsion, power management, sensor management, navigation, communication, actuation, steering, braking, and/or vehicle operation mode management.

The processing device 110 may house various circuits and devices used to control the operation of the robotic vehicle 101. For example, the processing device 110 may include a processor 120 that directs the control of the robotic vehicle 101. The processor 120 may include one or more processors configured to execute processor-executable instructions (e.g., applications, routines, scripts, instruction sets, etc.) to control operations of the robotic vehicle 101, including operations of various embodiments. In some embodiments, the processing device 110 may include memory 122 coupled to the processor 120 and configured to store data (e.g., navigation plans, obtained sensor data, received messages, applications, etc.). The processor 120 and memory 122, along with (but not limited to) additional elements such as a communication interface 124 and one or more input unit(s) 126, may be configured as or include a system-on-chip (SOC) 115.

The processing device 110 may include more than one SOC 115 thereby increasing the number of processors 120 and processor cores. The processing device 110 may also include processors 120 that are not associated with an SOC 115. Individual processors 120 may be multi-core processors. The processors 120 may each be configured for specific purposes that may be the same as or different from other processors 120 of the processing device 110 or SOC 115. One or more of the processors 120 and processor cores of the same or different configurations may be grouped together. A group of processors 120 or processor cores may be referred to as a multi-processor cluster.

The terms “system-on-chip” or “SOC” as used herein, refer to a set of interconnected electronic circuits typically, but not exclusively, including one or more processors (e.g., 120), a memory (e.g., 122), and a communication interface (e.g., 124). The SOC 115 may include a variety of different types of processors 120 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for an image capture system (e.g., 140) or a display processor for a display, an auxiliary processor, a single-core processor, and a multicore processor. The SOC 115 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SOC 115 may include one or more processors 120. The processing device 110 may include more than one SOC 115, thereby increasing the number of processors 120 and processor cores. The processing device 110 may also include processors 120 that are not associated with the SOC 115 (i.e., external to the SOC 115). Individual processors 120 may be multi-core processors. The processors 120 may each be configured for specific purposes that may be the same as or different from other processors 120 of the processing device 110 or the SOC 115. One or more of the processors 120 and processor cores of the same or different configurations may be grouped together. A group of processors 120 or processor cores may be referred to as a multi-processor cluster.

The processing device 110 may further include or be connected to one or more sensors(s) 136 that may be used by the processor 120 to determine information associated with vehicle operation and/or information associated with an external environment corresponding to the robotic vehicle 101 to control various processes on the robotic vehicle 101. Examples of such sensors 136 include accelerometers, gyroscopes and an electronic compass configured to provide data to the processor 120 regarding changes in orientation and motion of the robotic vehicle 101. For example, in some embodiments, the processor 120 may use data from sensors 136 as an input for determining or predicting the external environment of the robotic vehicle 101, for determining operation states of the robotic vehicle 101, and/or different exposure settings. One or more other input units 126 may also be coupled to the processor 120 for receiving data from sensor(s) 136 and the image capture system 140 or camera(s) 140a, 140b. Various components within the processing device 110 and/or the SOC 115 may be coupled together by various circuits, such as a bus 125, 135 or another similar circuitry.

In various embodiments, the processing device 110 may include or be coupled to one or more communication components 132, such as a wireless transceiver, an onboard antenna, and/or the like for transmitting and receiving wireless signals through the wireless communication link 25. The one or more communication components 132 may be coupled to the communication interface 124 and may be configured to handle wireless wide area network (WWAN) communication signals (e.g., cellular data networks) and/or wireless local area network (WLAN) communication signals (e.g., Wi-Fi signals, Bluetooth signals, etc.) associated with ground-based transmitters/receivers (e.g., base stations, beacons, Wi-Fi access points, Bluetooth beacons, small cells (picocells, femtocells, etc.), etc.). The one or more communication components 132 may receive data from radio nodes, such as navigation beacons (e.g., very high frequency (VHF) omni-directional range (VOR) beacons), Wi-Fi access points, cellular network base stations, radio stations, etc. In some embodiments, the one or more communication components 132 may be further configured to conduct communications with nearby autonomous vehicles (e.g., dedicated short-range communications (DSRC), etc.).

The processing device 110, using the processor 120, the one or more communication components 132, and an antenna may be configured to conduct wireless communications with a variety of wireless communication devices, examples of which include the base station or cell tower (e.g., base station 20), a beacon, server, a smartphone, a tablet, or another computing device with which the robotic vehicle 101 may communicate. The processor 120 may establish a bi-directional wireless communication link 25 via a modem and an antenna. In some embodiments, the one or more communication components 132 may be configured to support multiple connections with different wireless communication devices using different radio access technologies. In some embodiments, the one or more communication components 132 and the processor 120 may communicate over a secured communication link. The security communication links may use encryption or another secure means of communication in order to secure the communication between the one or more communication components 132 and the processor 120.

While the various components of the processing device 110 are illustrated as separate components, some or all of the components (e.g., the processor 120, the memory 122, and other units) may be integrated together in a single device or module, such as a system-on-chip module.

The robotic vehicle 101 may navigate or determine positioning using navigation systems, such as Global Navigation Satellite System (GNSS), Global Positioning System (GPS), etc. In some embodiments, the robotic vehicle 101 may use an alternate source of positioning signals (i.e., other than GNSS, GPS, etc.). The robotic vehicle 101 may use position information associated with the source of the alternate signals together with additional information for positioning and navigation in some applications. Thus, the robotic vehicle 101 may navigate using a combination of navigation techniques, camera-based recognition of the external environment surrounding the robotic vehicle 101 (e.g., recognizing a road, landmarks, highway signage, etc.), etc. that may be used instead of or in combination with GNSS/GPS location determination and triangulation or trilateration based on known locations of detected wireless access points.

In some embodiments, the processing device 110 of the robotic vehicle 101 may use one or more of various input units 126 for receiving control instructions, data from human operators or automated/pre-programmed controls, and/or for collecting data indicating various conditions relevant to the robotic vehicle 101. In some embodiments, the input units 126 may receive image data from an image capture system 140 including one or more cameras 140a, 140b, and provide such data to the processor 120 and/or memory 122 via an internal buss 135. Additionally, the input units 126 may receiving inputs from one or more of various other components, such as microphone(s), position information functionalities (e.g., a global positioning system (GPS) receiver for receiving GPS coordinates), operation instruments (e.g., gyroscope(s), accelerometer(s), compass(es), etc.), keypad(s), etc. The camera(s) may be optimized for daytime and/or nighttime operation.

In some embodiments, the processor 120 of the robotic vehicle 101 may receive instructions or information from a separate computing device, such as a remote server 40, that is in communication with the vehicle. In such embodiments, communications with the robotic vehicle 101 may be implemented using any of a variety of wireless communication devices (e.g., smartphones, tablets, smartwatches, etc.). Various forms of computing devices may be used to communicate with a processor of a vehicle, including personal computers, wireless communication devices (e.g., smartphones, etc.), servers, laptop computers, etc., to implement the various embodiments.

In various embodiments, the robotic vehicle 101 and the server 40 may be configured to communicate information associated with exposure settings, navigation information, and/or information associated with the environment surrounding the robotic vehicle 101. For example, information that may influence exposure settings may be communicated including information associated with locations, orientations (e.g., with respect to the direction of the sun), time of day, date, weather conditions (e.g., sunny, partly cloudy, rain, snow, etc.), etc. The robotic vehicle 101 may request such information and/or the server 40 may periodically send such information to the robotic vehicle 101.

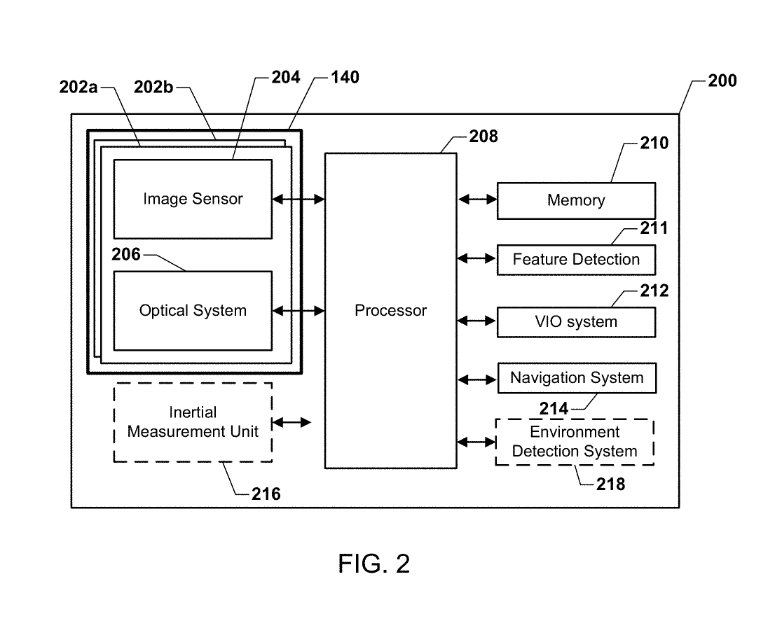

Various embodiments may be implemented within a robotic vehicle control system 200, an example of which is illustrated in FIG. 2. With reference to FIGS. 1-2, a control system 200 suitable for use with various embodiments may include an image capture system 140, a processor 208, a memory 210, a feature detection element 211, a Visual Odometry (VO) system 212, and a navigational system 214. In addition, the control system 200 may optionally include an inertial measurement unit (IMU) 216 and an environment detection system 218.

The image capture system 140 may include one or more cameras 202a, 202b, each of which may include at least one image sensor 204 and at least one optical system 206 (e.g., one or more lenses). A camera 202a, 202b of the image capture system 140 may obtain one or more digital images (sometimes referred to herein as image frames). The camera 202a, 202b may employ different types of image capture methods such as a rolling-shutter technique or a global-shutter technique. In addition, each camera 202a, 202b may include a single monocular camera, a stereo camera, and/or an omnidirectional camera. In some embodiments, the image capture system 140, or one or more cameras 204, may be physically separated from the control system 200, such a located on the exterior of the robotic vehicle and connect to the processor 208 via data cables (not shown). In some embodiments, the image capture system 140 may include another processor (not shown), which may be configured with processor-executable instructions to perform one or more of the operations of various embodiment methods.

Typically, the optical system 206 (e.g., one or more lenses) is configured to focus light from a scene within an environment and/or objects located within the field of view of the camera 202a, 202b onto the image sensor 204. The image sensor 204 may include an image sensor array having a number of light sensors configured to generate signals in response to light impinging on the surface of each of the light sensors. The generated signals may be processed to obtain a digital image that is stored in memory 210 (e.g., an image buffer). The optical system 206 may be coupled to and/or controlled by the processor 208. In some embodiments, the processor 208 may be configured to modify settings of the image capture system 140 such as exposure settings of the one or more cameras 202a, 202b or auto focusing actions by the optical system 306.

The optical system 206 may include one or more of a variety of lenses. For example, the optical system 206 may include a wide-angle lens, a wide-FOV lens, a fisheye lens, etc. or a combination thereof. In addition, the optical system 206 may include multiple lenses configured so that the image sensor 204 captures panoramic images, such as 200-degree to 360-degree images.

In some embodiments the memory 210, or another memory such as an image buffer (not shown) may be implemented within the image capture system 140. For example, the image capture system 140 may include an image data buffer configured to buffer (i.e., temporarily store) image data from the image sensor 204 before such data is processed (e.g., by the processor 208). In some embodiments, the control system 200 may include an image data buffer configured to buffer (i.e., temporarily store) image data from the image capture system 140. Such buffered image data may be provided to or accessible by the processor 208, or another processor configured to perform some or all of the operations over various embodiments.

The control system 200 may include a camera software application and/or a display such as a user interface (not illustrated). When the camera application is executed, images of one or more objects located in the environment within the field of view of the optical system 206 may be captured by the image sensor 204. Various settings may be modified for each camera 202 such as exposure settings, frame rates, focal length, etc.

The feature detection element 211 may be configured to extract information from one or more images captured by the image capture system 140. For example, the feature detection element 211 may identify one or more points associated with an object appearing with any two image frames. For example, one or a combination of high contrast pixels may be identified as points used by the VO system 212 for tracking within a sequence of image frames. Any known shape recognition method or technique may be used to identify one or more points associated with portions of objects or details within an image frame for tracking. In addition, the feature detection element 211 may measure or detect a location (e.g., a coordinate value) of the identified one or more points associated with the object within the image frames. The detected location of the identified one or more points associated with the object within each image frame may be stored in the memory 210.

In some embodiments, the feature detection element 211 may further determine whether an identified feature point is a valid point as well as selecting points to provide to the VO system 212 that have a higher confidence score. Typically, in CV and MV systems, a single camera operating at a single exposure setting is used to capture sequential image frames. While environmental factors may change over time, the influence of the environmental factors on adjacent image frames captured in a sequence may be minimal. Thus, the one or more points may be identified using known point identification techniques in a first image frame and then identified and tracked relatively easily between two adjacent image frames because the identified one or more points will appear in the image frame at substantially the same brightness value.

By capturing a second image using a second exposure setting, the feature detection element 211 in various embodiments may identify additional points for tracking that would not be detected or resolved when using a single exposure setting. Due to the differences in contrast and/or pixel brightness values created by implementing different exposure settings during image capture, the feature detection element 211 may identify the same, different, and/or additional points appearing in image frames capturing substantially the same field of view at different exposure settings. For example, if an image frame is captured using an exposure setting that creates an underexposed image, points associated with high contrast areas may be more identifiable as well as key points obscured due to light saturation or pixel brightness averaging. If an image frame is captured using an exposure setting that creates an overexposed image, points associated with low contrast areas may be more identifiable.

In some embodiments, the image frames may be captured by the same or different cameras (e.g., cameras 140a, 140b) such that adjacent image frames have the same or different exposure settings. Thus, the two image frames used to identify the points may have the same or different exposure levels.

The feature detection element 211 may further predict the identified points that will allow the VO system 212 to more accurately and/or more efficiently generate data used by the navigation system 214 to perform navigation techniques including self-localization, path planning, map building, and/or map interpretation. For example, the feature detection element 211 may identify X number of points in a first image frame captured at a first exposure setting and Y number of points in a second image frame captured at a second exposure setting. Therefore, the total number of identified points within the scene will be X+Y. However, some of the points identified from the first image frame may overlap some of the points identified from the second image frame. Alternatively, or in addition, all of the identified points may not be necessary to accurately identify key points within the scene. Therefore, the feature detection element 211 may assign a confidence score to each identified point and then select the identified points that are within a threshold range to provide to the VO system 212. Thus, the feature detection element 211 may pick and choose the better points that will more accurately and/or efficiently generate data used by the navigation system 214.

The VO system 212 of the control system 200 may be configured to use the points identified by the feature detection element 211 to identify and track key points across multiple frames. In some embodiments, the VO system 212 may be configured to determine, estimate, or predict a relative position, velocity, acceleration, and/or orientation of the robotic vehicle 101. For example, the VO system 212 may determine a current location of a key point, predict a future location of the key point, predict or calculate motion vectors, etc. based on one or more image frames, points identified by the feature detection element 211, and/or measurements provided by the IMU 216. The VO system may be configured to extract information from the one or more images, points identified by the feature detection element 211, and/or measurements provided by the IMU 216 to generate navigation data that the navigation system 214 may use to navigate the robotic vehicle 101 within the environment. While the feature detection element 211 and the VO system 212 are illustrated in FIG. 2 as separate elements, the feature detection element 211 may be incorporated within the VO system 212 or other systems, modules or components. Various embodiments may also be useful for a collision avoidance system, in which case images taken at the two (or more) exposure settings may be processed collectively (e.g., together or sequentially) to recognize and classify objects, and track the relative movements of objects from image to image, to enable the robotic vehicle to maneuver to avoid colliding with objects.

In some embodiments, the VO system 212 may apply one or more image processing techniques to the captured images. For instance, the VO system 212 may detect one or more features, objects or points within each image, track the features, objects or points across multiple frames, estimate motion of the features, objects or points based on the tracking results to predict future point locations, identify one or more regions of interest, determine depth information, perform bracketing, determine frame of reference, etc. Alternatively, or additionally, the VO system 212 may be configured to determine pixel luminance values for a captured image. The pixel luminance values may be used for brightness threshold purposes, edge detection, image segmentation, etc. The VO system 212 may generate a histogram corresponding to a captured image.

The navigation system 214 may be configured to navigate within the environment of the robotic vehicle 101. In some embodiments, the navigation system 214 may determine various parameters used to navigate within the environment based on the information extracted by the VO system 212 from the images captured by the image capture system 140. The navigation system 214 may perform navigation techniques to determine a current position of the robotic vehicle 101, determine a goal location, and identify a path between the current position and the goal location.

The navigation system 214 may navigate within the environment using one or more of self-localization, path planning, and map building and/or map interpretation. The navigation system 214 may include one or more of a mapping module, a three-dimensional obstacle mapping module, a planning module, a location module, and a motion control module.

The control system 200 may optionally include an inertial measurement unit 216 (IMU) configured to measure various parameters of the robotic vehicle 101. The IMU 216 may include one or more of a gyroscope, an accelerometer, and a magnetometer. The IMU 216 may be configured to detect changes in pitch, roll, and yaw axes associated with the robotic vehicle 101. The IMU 216 output measurements may be used to determine altitude, angular rates, linear velocity, and/or position of the robotic vehicle 101. In some embodiments, the VO system 212 and/or the navigation system 214 may further use a measurement output by the IMU 216 to extract information from the one or more images captured by the image capture system 140 and/or navigate within the environment of the robotic vehicle 101.

In addition, the control system 200 may optionally include an environment detection system 218. The environment detection system 218 may be configured to detect various parameters associated with the environment surrounding the robotic vehicle 101. The environment detection system 218 may include one or more of an ambient light detector, a thermal imaging system, an ultrasonic detector, a radar system, an ultrasound system, a piezoelectric sensor, a microphone, etc. In some embodiments, the parameters detected by the environment detection system 218 may be used to detect environment luminance levels, detect various objects within the environment, identify locations of each object, identify object material, etc. The VO system 212 and/or the navigation system 214 may further use the measurements output by the environment detection system 218 to extract information from the one or more images captured by the one or more cameras 202 (e.g., 140a, 140b) of the image capture system 140, and use such data to navigate within the environment of the robotic vehicle 101. In some embodiments, one or more exposure settings may be determined based on the measurements output by the environment detection system 218.

In various embodiments, one or more of the images captured by the one or more cameras of the image capture system 140, the measurements obtained by the IMU 216, and/or the measurements obtained by the environment detection system 218 may be timestamped. The VO system 212 and/or the navigation system 214 may use the timestamp information to extract information from the one or more images captured by the one or more cameras 202 and/or navigate within the environment of the robotic vehicle 101.

The processor 208 may be coupled to (e.g., in electronic communication with) the image capture system 140, the one or more image sensors 204, the one or more optical systems 206, the memory 210, the feature detection element 211, the VO system 212, the navigation system 214, and optionally the IMU 216, and the environment detection system 218. The processor 208 may be a general-purpose single-chip or multi-chip microprocessor (e.g., an ARM processor), a special-purpose microprocessor (e.g., a digital signal processor (DSP)), a microcontroller, a programmable gate array, etc. The processor 208 may be referred to as a central processing unit (CPU). Although a single processor 208 is illustrated in FIG. 2, the control system 200 may include multiple processors (e.g., a multi-core processor) or a combination of different types of processors (e.g., an ARM and a DSP).

The processor 208 may be configured to implement the methods of various embodiments to navigate the robotic vehicle 101 within an environment and/or determine one or more exposure settings of the one or more cameras 202a, 202b of image capture system 140 used to capture images. While illustrated in FIG. 2 as separate from the VO system 212 and the navigation system 214, the VO system 212 and/or the navigation system 214 may be implemented in hardware or firmware, as a module executing on the processor 208, and/or in a combination of hardware, software, and/or firmware.

The memory 210 may store data (e.g., image data, exposure settings, IMU measurements, timestamps, data associated with the VO system 212, data associated with the navigation system 214, etc.) and instructions that may be executed by the processor 208. Examples of instructions and/or data that may be stored in the memory 210 in various embodiments may include image data, gyroscope measurement data, camera auto-calibration instructions including object detection instructions, object tracking instructions, object location predictor instructions, timestamp detector instructions, calibration parameter calculation instructions, calibration parameter(s)/confidence score estimator instructions, a calibration parameter/confidence score variance threshold data, a detected object location of a current frame data, a predated object location in the next frame data, calculated calibration parameter data, etc. The memory 210 may be any electronic component capable of storing electronic information, including for example random access memory (RAM), read-only memory (ROM), magnetic disk storage media, optical storage media, flash memory devices in RAM, on-board memory included with the processor, erasable programmable read only memory (EPROM), electrically erasable programmable read only memory (EEPROM), registers, and so forth, including combinations thereof.

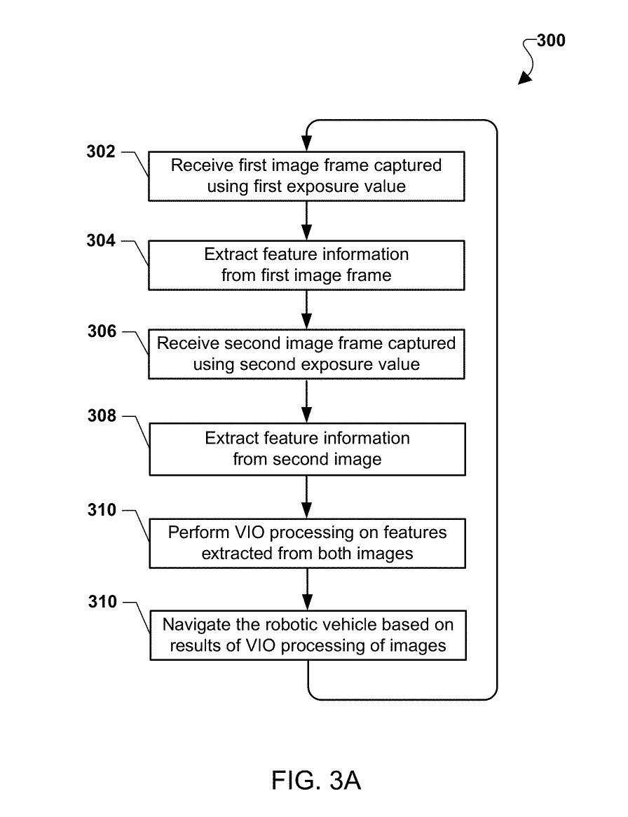

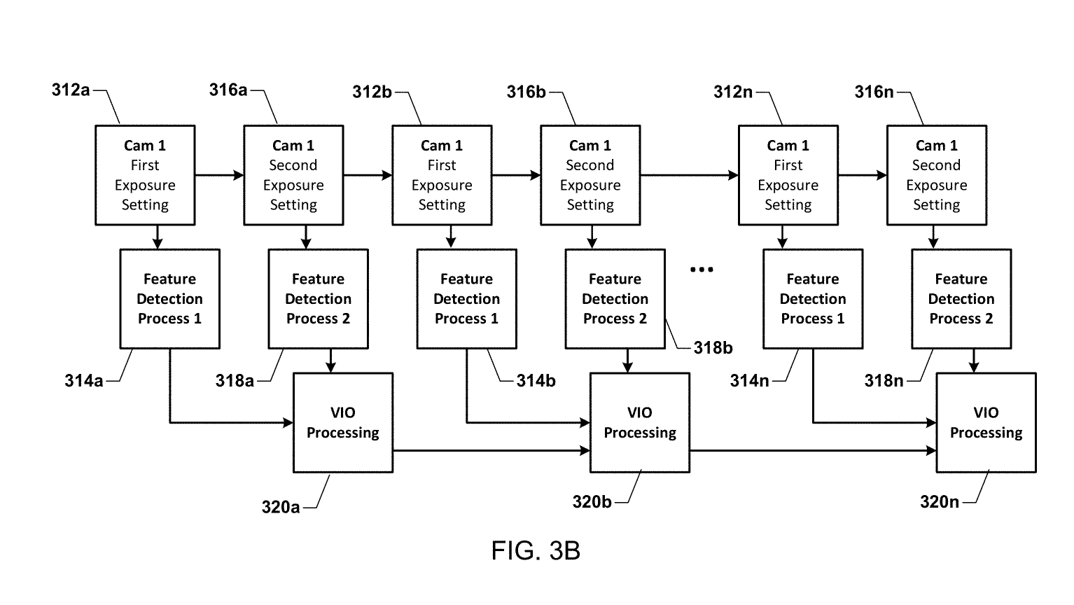

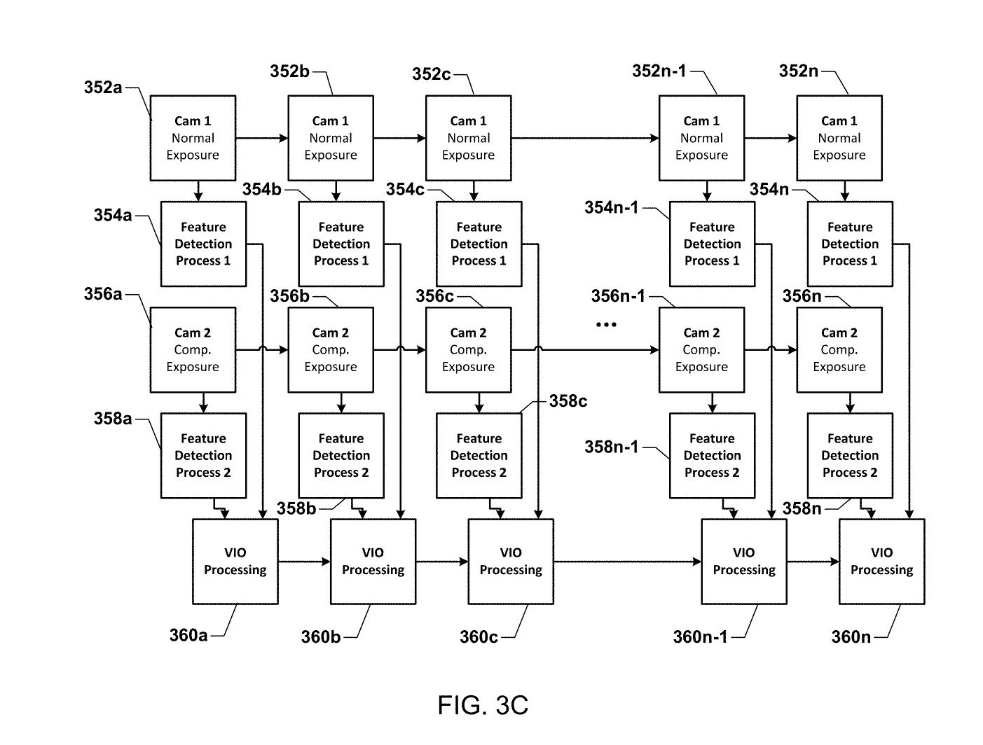

FIG. 3A illustrates a method 300 of navigating a robotic vehicle (e.g., robotic vehicle 101 or 200) according to various embodiments. With reference to FIGS. 1-3A, the method 300 may be implemented by one or more processors (e.g., processor 120, 208 and/or the like) of the robotic vehicle (e.g., 101) exchanging data and control commands with an image capture system (e.g., 140) that may include one or more cameras (e.g., 140a, 140b, 202a, 202b).

In block 302, the processor may receive a first image frame captured using a first exposure setting. For example, the first image frame may be captured by the image sensor (e.g., 204) of a camera of the image capture system such that the first image frame includes one or more objects within the field of view of the image capture system.

In block 304, the processor may extract information from the first image frame to perform feature detection. For example, the processor may identify one or more feature points within the first image frame. The identified feature points may be based on the contrast and/or brightness values between adjacent pixels created using the first exposure setting.

In block 306, the processor may receive a second image frame captured using a second exposure setting different from the first exposure setting. The second exposure setting may be greater than or less than the first exposure setting. In some embodiments, the second image frame may be captured by the image sensor 204 of the same camera 202a that captured the first image frame. In other embodiments, the second image frame may be captured by an image sensor 204 of a second camera (e.g., 202b) of the image capture system different from a first camera (e.g., 202a) used to capture the first image frame. When the first and second image frames are captured using two different cameras, the first image frame may be captured at approximately the same time as the second image frame is captured (i.e., approximately simultaneously). In embodiments in which the different exposure settings involve obtaining images for different exposure times, the first image frame may be captured during a time that overlaps with the time during which the second image frame is captured.

The first exposure setting and the second exposure setting may correspond to (i.e., appropriate for capturing images in) different brightness ranges. In some embodiments, the brightness range associated with the first exposure setting may be different from the brightness range associated the second exposure setting. For example, the brightness range associated with the second exposure setting may complement the brightness range associated with the first exposure setting such that the brightness range associated with the second exposure setting does not overlap with the brightness range associated with the first exposure setting. Alternatively, at least a portion of the brightness range associated with the first exposure setting and at least a portion of the brightness range associated with the second exposure setting may overlap.

In block 308, the processor may extract information from the second image frame to perform feature detection. For example, the processor may identify one or more feature points or key points within the second image frame. The identified feature/key points may be based on the contrast and/or brightness values between adjacent pixels created using the second exposure setting. The one or more feature/key points identified may be the same or different from the feature/key points identified from the first image frame.

In block 310, the processor may perform VO processing using at least some of the feature points or key points identified from the first image frame and the second image frame to generate data used for navigation of the robotic vehicle. For example, the processor may track one or more key points by implementing a first visual tracker for one or more sets of key points identified from the first image frame captured using the first exposure setting and a second visual tracker for one or more sets of key points identified from the second image frame. The term “visual tracker” is used herein to refer to a set of operations executing in a processor that identify a set of key points in images, predict the location of those key points in subsequent images, and/or determine the relative movement of those key points across a sequence of images. The processor may then track the identified key points between subsequent image frames captured using the first exposure setting using the first visual tracker and the identified key points between subsequent image frames captured using the second exposure setting using the second visual tracker.

In some embodiments, the VO processing may further determine, estimate, and/or predict a relative position, velocity, acceleration, and/or orientation of the robotic vehicle based on the feature/key points identified from the first image frame and the second image frame. In some embodiments, the processor may estimate where each of the identified feature/key points are within a three-dimensional space.

In block 312, the processor may determine navigational information based on the data generated as a result of the VO processing and use such information to navigate the robotic vehicle within the environment. For example, the processor may perform self-localization, path planning, map building, and/or map interpretation in order to create instructions to navigate the robotic vehicle within the environment.

The method 300 may be performed continuously as the robotic vehicle moves within the environment. Also, various operations of the method 300 may be performed more or less in parallel. For example, the operations of capturing images in blocks 302 and 306 may be performed in parallel with operations that extract features and/or or key points from the images in blocks 304 and 308. As another example, VO processing in block 310 and navigation of the robotic vehicle in block 310 may be performed more or less in parallel with the image capture and analysis processes in blocks 302-308 such that VO processing and navigation operations are performed on information obtained from a previous set of images while a next or subsequent set of images are obtained and processed.

In some embodiments, a robotic vehicle processor may be continually looking for regions of dramatically different brightnesses. The robotic vehicle processor may adjust the exposure setting associated with the camera that captures the first image frame and/or the second image frame in order to capture images at or within different brightness ranges detected by the robotic vehicle.

In some embodiments in which the image capture system (e.g., 140) of the robotic vehicle includes two or more cameras, a primary camera may analyze an environment surrounding the robotic vehicle at a normal or default exposure level, and a secondary camera may adjust the exposure setting used by the secondary camera based on the exposure setting used by the primary camera and measurements of the brightness range (sometimes referred to as the “dynamic range”) of the environment. In some embodiments, the exposure setting selected for the secondary camera may complement or overlap the exposure setting selected for the primary camera. The robotic vehicle processor may leverage information regarding the exposure setting of the primary camera when setting the exposure on the secondary camera in order to capture images within a dynamic range that complement the exposure level of the primary camera.

The use of different exposure settings for each image frame enables the robotic vehicle to scan the surrounding environment and to navigate using a first camera while also having the benefit of information about key points, features and/or objects with a brightness value outside the dynamic range of the first camera. For example, various embodiments may enable the VO process implemented by the robotic vehicle processor to include analysis of key points/features/objects that are inside a building or other enclosure when the robot is outside before the robotic vehicle enters through a doorway. Similarly, the robotic vehicle processor may include analysis of key points/features/objects that are outside a building or other enclosure when the robot is inside before the robotic vehicle exits through a doorway.

Examples of process systems that implement the method 300 to capture the first image frame and the second image frame are illustrated in FIGS. 3B-3C. With reference to FIGS. 1-3B, a single camera (“Cam 1”) may be configured to capture image frames alternating between using the first exposure setting and using the second exposure setting. A first image frame may be captured in block 312a by the single camera using the first exposure setting. Then the exposure setting of the single camera may be modified to a second exposure setting and a second image frame may be captured in block 316a. A first feature detection process “Feature Detection Process 1” may be performed by a processor in block 314a on the first image frame obtained in block 312a and a second feature detection process “Feature Detection Process 2” may be performed by the processor in block 318a on the second image frame obtained in block 316a. For example, the feature detection processes performed in blocks 314a and 318a may identify key points within each image frame, respectively. Information associated with the key point data extracted during the feature detection processes performed in blocks 314a and 318a may be provided to a processor performing VIO (or VO) navigation to enable VIO (or VO) processing in block 320a. For example, the extracted key point data may be communicated to the processor perform VIO (or VO) navigation via a data bus and/or by storing the data in a series of registers or cache memory accessible by that processor. In some embodiments, the processor performing the feature detection processes in blocks 314a and 318a and the processor performing VIO (or VO) navigation processes may be the same processor, with the feature detection and navigation processes being performed sequentially or in parallel. While the processing in blocks 320a-320n is labeled as being VIO processing in FIG. 3B, the operations performed in blocks 320a-320n may be or include VO processing.

Subsequently, the exposure setting of the single camera may be modified from the second exposure setting back to the first exposure setting to capture an image frame in block 312b using the first exposure setting. After the first image frame is captured in block 312b, the exposure setting of the single camera may be modified from the first exposure setting to the second exposure setting to capture a second image frame in block 316b. Feature detection 314b may be performed by a processor on the first image frame in block 314b and feature detection may be performed by the processor on the second image frame in block 316b. The results of the feature detection operations performed in blocks 314b and 316b, as well as the results of VIO processing performed in block 320a, may be provided to the processor performing VIO (or VO) processing in block 320b. This process may be repeated for any number of n image frames in blocks 312n, 314n, 316n, 318n, 320n. The results of the VIO (or VO) processing 320a, 320b . . . 320n may be used to navigate and otherwise control the robotic vehicle.

In some embodiments, two (or more) cameras may be use to capture contrast to a single camera capturing the image frames using two (or more) exposure settings. FIG. 3C illustrates an example process that uses a first camera (“Cam 1”) configured to capture image frames at a first exposure setting (e.g., a “normal” exposure) and a second camera (“Cam 2”) configured to capture image frames at a second exposure setting (e.g., a complementary exposure). With reference to FIGS. 1-3C, the operations performed in blocks 352a-352n, 354a-354n, 356a-356n, 358a-358n and 360a-360n shown in FIG. 3C may be substantially the same as the operations described in blocks 312a-312n, 314a-314n, 316a-316n, 318a-318n, and 320a-320n with reference to FIG. 3B, with the exception that first and second images frames 352a-352n and 356a-356n may be obtained by different cameras. In addition, the first and second image frames 352a-352n and 356a-356n may be processed for feature detection in blocks 354a-354n and blocks 358a-358n, respectively. The capture of the first and second images frames 352a-352n and 356a-356n and/or the feature detection performed in blocks 354a-354n and 358a-358n, respectively may be performed approximately in parallel or sequentially in some embodiments. Using two (or more) cameras to obtain two (or more) images at different exposure approximately simultaneously may aid in VIO (or VO) processing as features and key points will not shift position between the first and second images due to movement of the robotic vehicle between capture of the images.

For clarity, only two cameras implementing a normal exposure setting and a complementary exposure setting are illustrated in FIG. 3C. However, various embodiments may be implemented using any number of cameras (e.g., N cameras), image frames (e.g., N images), and/or different exposure settings (e.g., N exposure settings). For example, in some embodiments three cameras may be used in which a first image is obtained by a first camera at a first exposure setting (e.g., encompassing a middle portion of the camera's dynamic range), a second image is obtained by a second camera at a second exposure setting (e.g., encompassing brightest portion of the camera's dynamic range), and third image is obtained by a third camera at a third exposure setting (e.g., encompassing a dim-to-dark portion of the camera's dynamic range).

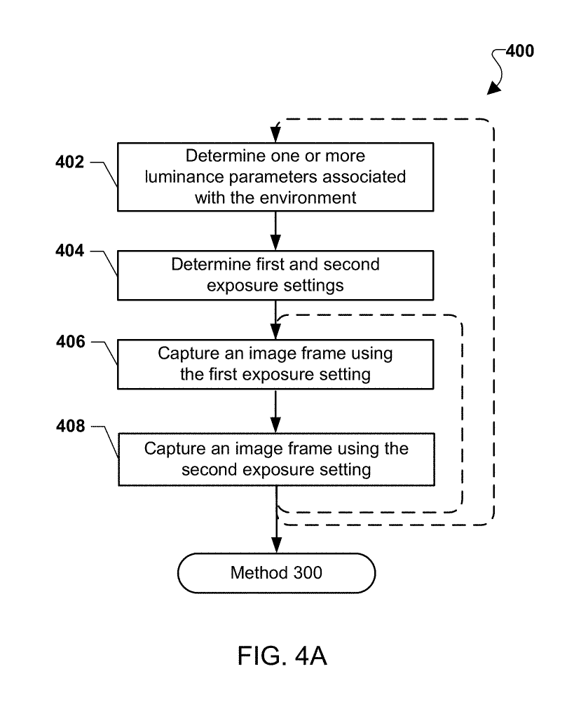

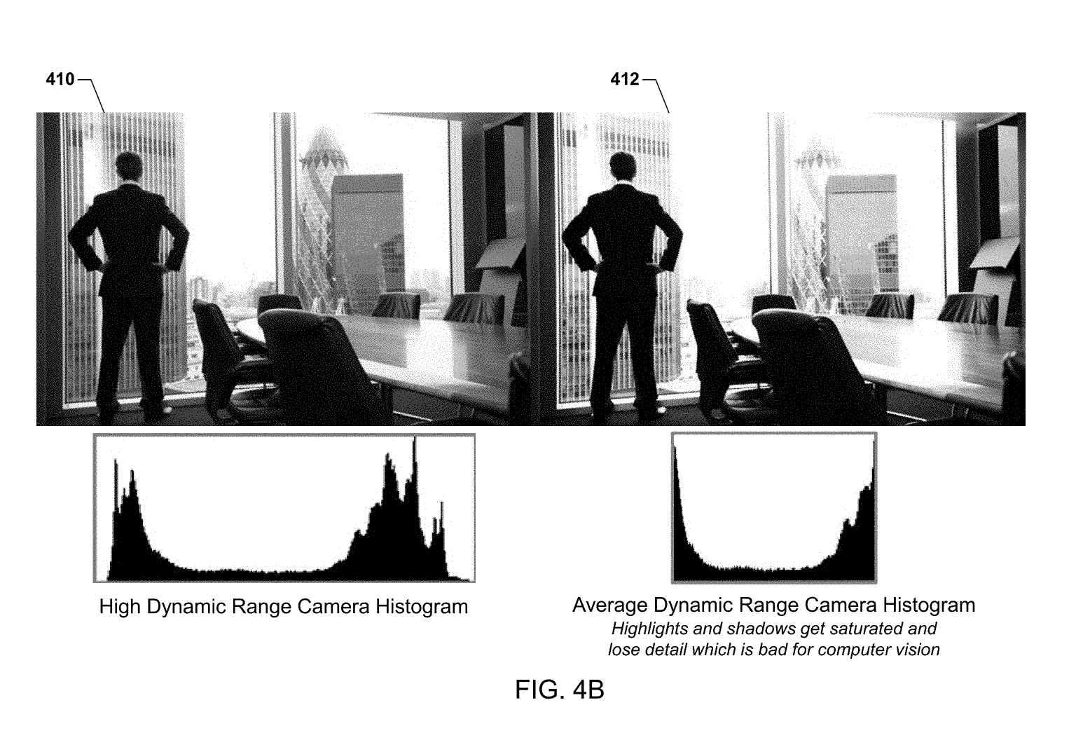

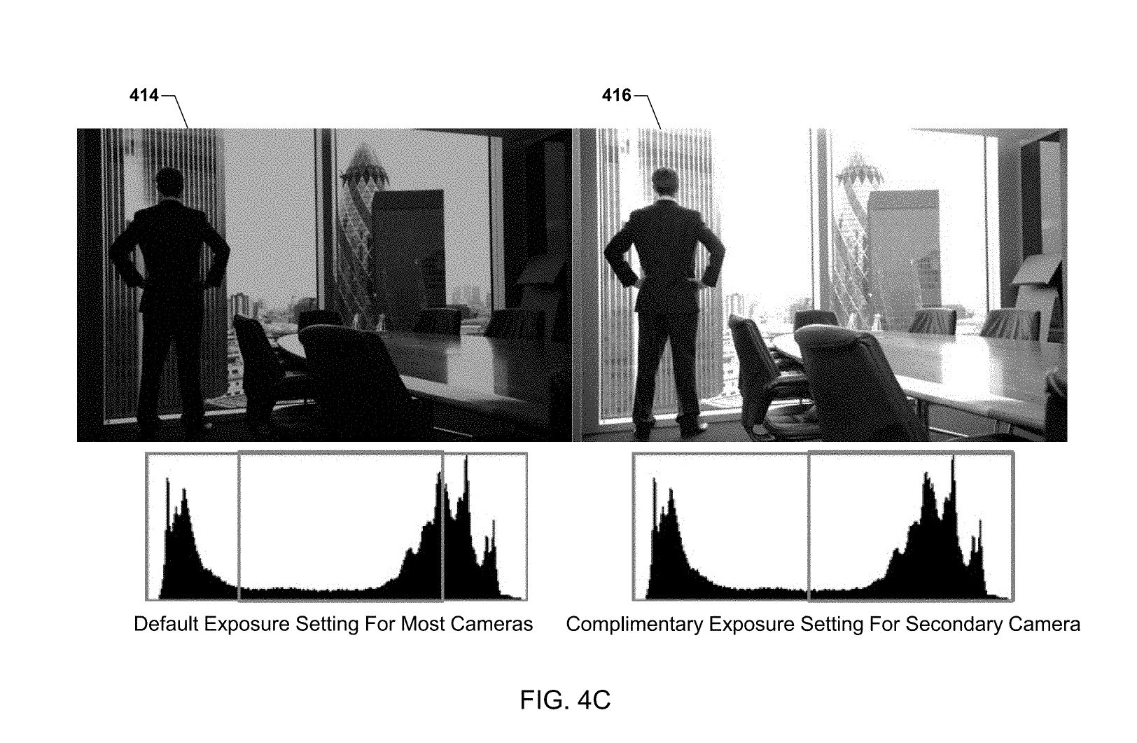

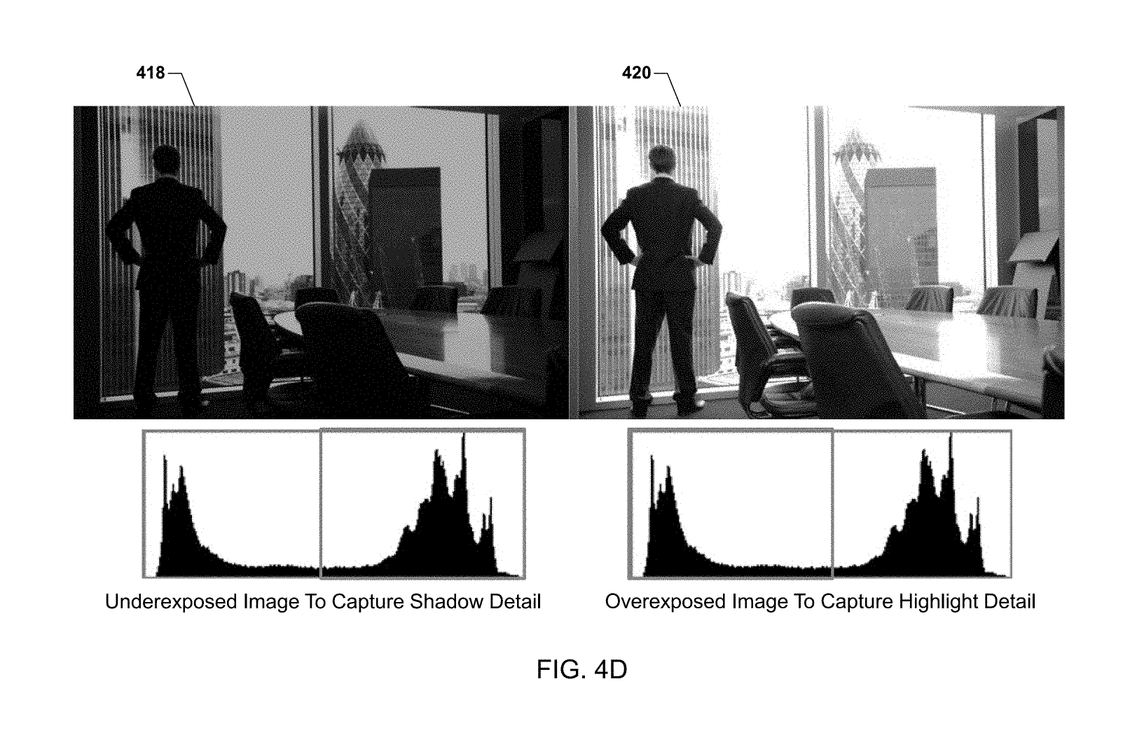

FIG. 4A illustrates a method 400 for capturing images by a robotic vehicle (e.g., robotic vehicle 101 or 200) within an environment according to various embodiments. With reference to FIGS. 1-4A, the method 400 may be implemented by one or more processors (e.g., processor 120, 208 and/or the like) of a robotic vehicle (e.g., 101) exchanging data and control commands with an image capture system (e.g., 140) that may include one or more cameras (e.g., 140a, 140b, 202a, 202b).

In block 402, the processor may determine a luminance parameter associated with the environment of the robotic vehicle. The luminance parameter may be based on an amount of light that is emitted, reflected, and/or refracted within the environment. For example, the luminance parameter may correspond to a brightness value or a range of brightness values that indicate the amount of light measured or determined within the environment. The luminance parameter may be one or more of an average brightness of the scene, an overall range of brightness distribution, a number of pixels associated with a brightness value, and a number of pixels associated with a range of brightness values.

The amount of light present within the environment (sometimes referred to herein as a “luminance parameter”) may be measured or determined in various ways. For example, the amount of light present within the environment may be measured using a light meter. Alternatively, or in addition, the amount of light present within the environment may be determined from an image frame captured by one or more cameras (e.g., camera 202a, 202b) of an image capture system (e.g., 140) and/or a histogram of brightness generated from an image frame captured by the one or more cameras.

In block 404, the processor may determine a first exposure setting and a second exposure setting based on the determined luminance parameter. In some embodiments, the first exposure setting and the second exposure setting may be selected from a plurality of predetermined exposure settings based on the luminance parameter. Alternatively, the first exposure setting or the second exposure setting may be dynamically determined based on the luminance parameter.

Each exposure setting may include various parameters including one or more of an exposure value, a shutter speed or exposure time, a focal length, a focal ratio (e.g., f-number), and an aperture diameter. One or more parameters of the first exposure setting or the second exposure setting may be selected and/or determined based on one or more determined luminance parameters.

As discussed above, the operations in block 404 may be implemented by one or more processors (e.g., processor 120, 208 and/or the like) of the robotic vehicle (e.g., 101). Alternatively or in addition, in some embodiments, the image capture system (e.g., 140) or the cameras (e.g., camera(s) 202a, 202b) may include a processor (or processors) that may be configured to collaborate and actively engage with the one or more cameras to perform one or more of the operations of block 404 to determine the best exposure settings to be implemented to capture the first and second image frames.

In various embodiments, the processor of the image capture system (e.g., 140) or associated with at least one of the cameras may be dedicated to camera operations and functionality. For example, when a plurality of cameras are implemented in the image capture system, the processor may be a single processor in communication with the plurality of cameras that is configured to actively engage in balancing exposures of each of the plurality of cameras within the image capture system. Alternatively, each camera may include a processor and each camera processor may be configured to collaborate and actively engage with each of the other camera processor to determine an overall image capture process including desired exposure settings for each camera.

For example, in a system with two or more cameras each equipped with a processor, the processors within the two or more cameras may actively engage with each other (e.g., exchanged data and processing results) to collaboratively determine the first and second exposure settings based on where the first and second exposure settings intersect and how much the first and second exposure settings overlap. For instance, a first camera may be configured to capture image frames within a first portion of the dynamic range associated with the scene and the second camera may be configured to capture image frames within a second portion of the dynamic range associated with the scene different from the first portion of the dynamic range. The two or more camera processors may collaborate to determine the location and/or range of the first and second exposure settings with respect to the dynamic range because where the first and second exposure settings may intersect with respect to the dynamic range of the scene and/or how much the range of the first and second exposure settings overlap may be constantly evolving.

In some embodiments, the first camera may be continuously assigned an exposure setting associated with a “high” exposure range (e.g., an exposure setting corresponding to brighter pixel values including highlights) and the second camera may be assigned an exposure setting associated with a “low” exposure range (e.g., an exposure setting corresponding to darker pixel values including shadows). However, the various parameters, including one or more of the exposure value, the shutter speed or exposure time, the focal length, the focal ratio (e.g., f-number), and the aperture diameter, may be modified in response to the collaborative engagement between the two or more cameras in order to maintain a desired intersection threshold and/or overlap threshold between the exposure settings assigned to the first camera and the second camera, respectively.

In block 406, the processor may instruct the camera to capture an image frame using the first exposure setting, and in block 408, the processor may instruct the camera to capture an image frame using the second exposure setting. The images captured in blocks 406 and 408 may be processed according to the operations in the method 300 as described.

In some embodiments, the determination of the luminance parameters and of the first and second exposure settings may be performed episodically, periodically or continuously. For example, the camera may continue to capture image frames using the first exposure setting and the second exposure setting in blocks 406 and 408 until some event or trigger (e.g., an image processing operation determining that one or both of the exposure settings is resulting in poor image quality), at which point the processor may repeat the method 400 by determining the one or more luminance parameters associated with the environment in block 402 and determining the exposure settings in block 404. As another example, the camera may capture image frames using the first exposure setting and the second exposure setting in blocks 406 and 408 a predetermined number of times before determining the one or more luminance parameters associated with the environment in block 402 and determining the exposure settings in block 404. As another example, all operations of the method 400 may be repeated each time images are captured.

Examples of image frames captured at two different exposure settings per the methods 300 or 400 are illustrated in FIGS. 4B-4D. For clarity and ease of discussion, only two image frames are illustrated and discussed. However, any number of image frames and different exposure settings may be used.

Referring to FIG. 4B, the first image frame 410 was captured using a high dynamic range camera at an average exposure setting and the second image frame 412 was captured using a camera having an average dynamic range. The second image frame 412 illustrates pixel saturation as well as a reduction in contrast due to the saturation of highlights and shadows included in the second image frame 412.

Referring to FIG. 4C, the first image frame 414 was captured using a camera using a default exposure setting and the second image frame 416 was captured using an exposure setting that complements the exposure setting used to capture the first image frame 414. For example, the second image frame 504 may be captured at an exposure setting selected based on a histogram of the first image frame 504 such that the exposure setting corresponds to a high concentration of pixels within a tonal range.

Referring to FIG. 4D, the first image frame 418 was captured using a first exposure setting that captures an underexposed image in order to capture shadow detail within the first image frame 418. The second image frame 420 was captured using a second exposure setting that captures an overexposed image in order to capture the highlight detail within the second image frame 420. For example, as illustrated in FIG. 4D, the first exposure setting and the second exposure settings may be selected from opposite ends of a histogram of the dynamic range or luminance of the environment.

In some embodiments, a single camera may be implemented to capture image frames by interleaving a plurality of different exposure settings as illustrated in FIG. 3B. Alternatively, two or more cameras may be implemented to capture image frames such that a first camera may be configured to capture an image frame using the first exposure setting, a second camera may be configured to capture an image frame using the second exposure setting (e.g., as illustrated in FIG. 3C), a third camera may be configured to capture an image frame using a third exposure setting, etc.

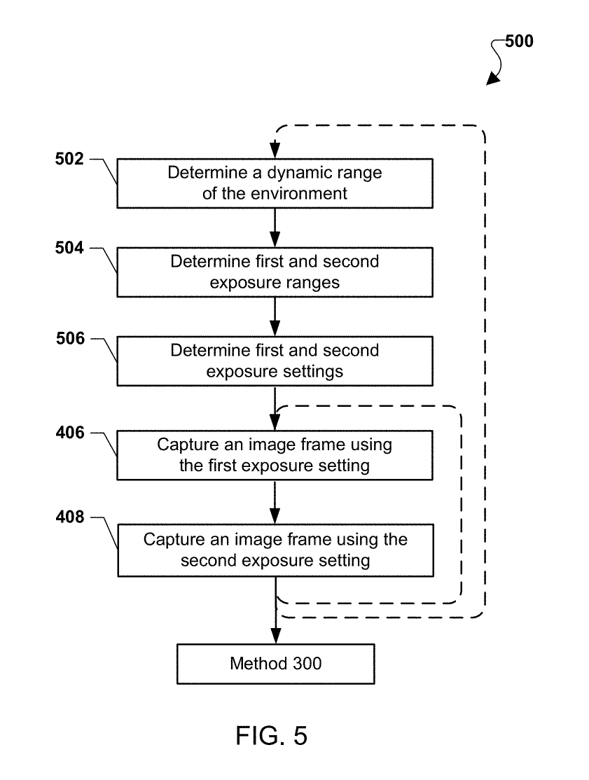

FIG. 5 illustrates another method 500 for capturing images by a robotic vehicle (e.g., robotic vehicle 101 or 200) within an environment according to various embodiments. With reference to FIGS. 1-5, the method 500 may be implemented by one or more processors (e.g., processor 120, 208 and/or the like) of a robotic vehicle (e.g., 101) exchanging data and control commands with an image capture system (e.g., 140) that may include one or more cameras (e.g., 140a, 140b, 202a, 202b).

In block 502, the processor may determine the dynamic range of the scene or environment within the field of view of the robotic vehicle. Determining the dynamic range may be based on the amount of light detected within the environment (e.g., via a light meter or analysis of captured images) and/or the physical properties of the image sensor of the camera (e.g., image sensor 204). In some embodiments, the processor may determine the dynamic range based on a minimum pixel brightness value and a maximum pixel brightness value that corresponds to the amount of light detected within environment.

In block 504, the processor may determine a first exposure range and a second exposure range based on the determined dynamic range. The first and second exposure ranges may be determined to be within any portion of the dynamic range. For example, the first and second exposure ranges may be determined such that the entire dynamic range is covered by at least a portion of the first exposure range and the second exposure range. As another example, the first or second exposure ranges may be determined such that the first and second exposure ranges overlap for a portion of the determined dynamic range. As another example, the first or second exposure ranges may be determined such that the first and second exposure ranges do not overlap. In some embodiments, the first and second exposure ranges may correspond to separate portions of the dynamic range.

In some embodiments, the processor may determine the first exposure range and the second exposure range based on detecting a predetermined luminance value within the environment. For example, the processor may determine that the scene exhibits a luminance value that may result in the camera capturing an image frame that includes a significantly underexposed region and/or overexposed region, which may undesirably affect the robotic vehicle's ability to identify and/or track key points within the image frame(s). In such a case, the processor may optimize the first and second exposure ranges to minimize the influence of the luminance value. For example, the processor may ignore brightness values that correspond to the anticipated underexposed and/or overexposed region in determining the first exposure range, and determine the second exposure range based on the range of brightness values ignored in determining the first exposure range.

For example, in a situation in which the robotic vehicle is in a dark tunnel and headlights of a car enter the field of view of the one or more cameras, the processor may determine the first exposure range based on all the brightness values detected within the surrounding environment of the tunnel except for the brightness values associated with the headlights of the car, and determine the second exposure range based on only the brightness values associated with the headlights of the car.

In block 506, the processor may determine the first and second exposure settings based on the first and second exposure ranges, respectively. For example, one or more of an exposure value, a shutter speed or exposure time, a focal length, a focal ratio (e.g., f-number), and an aperture diameter may be determined based on the first exposure range or the second exposure range to create the first exposure setting and the second exposure setting, respectively.

In block 406, the processor may instruct the camera to capture an image frame using the first exposure setting and in block 408, the processor may instruct the camera to capture an image frame using the second exposure setting. The images captured in blocks 406 and 408 may be processed according to the operations in the method 300 as described.

In some embodiments, the determination of the dynamic range of the environment in block 502, the determination of the first and second exposure ranges in block 504, and the determination of the first and second exposure settings in block 506 may be performed episodically, periodically or continuously. For example, the camera may continue to capture image frames using the first exposure setting and the second exposure setting in blocks 406 and 408 until some event or trigger (e.g., an image processing operation determining that one or both of the exposure settings is resulting in poor image quality), at which point the processor may repeat the method 500 by again determining the dynamic range of the environment in block 502, the determination of the first and second exposure ranges in block 504, and the determination of the of the first and second exposure settings in block 506. As another example, the camera may capture image frames using the first exposure setting and the second exposure setting in blocks 406 and 408 a predetermined number of time before again determining the dynamic range of the environment in block 502, the determination of the first and second exposure ranges in block 504, and the determination of the of the first and second exposure settings in block 506. As another example, all operations of the method 500 may be repeated each time images are captured.

Any number of exposure algorithms may be implemented for determining the dynamic range of a scene or the environment. In some embodiments, the combination of the exposure settings included in the exposure algorithms may cover the entire dynamic range of the scene.

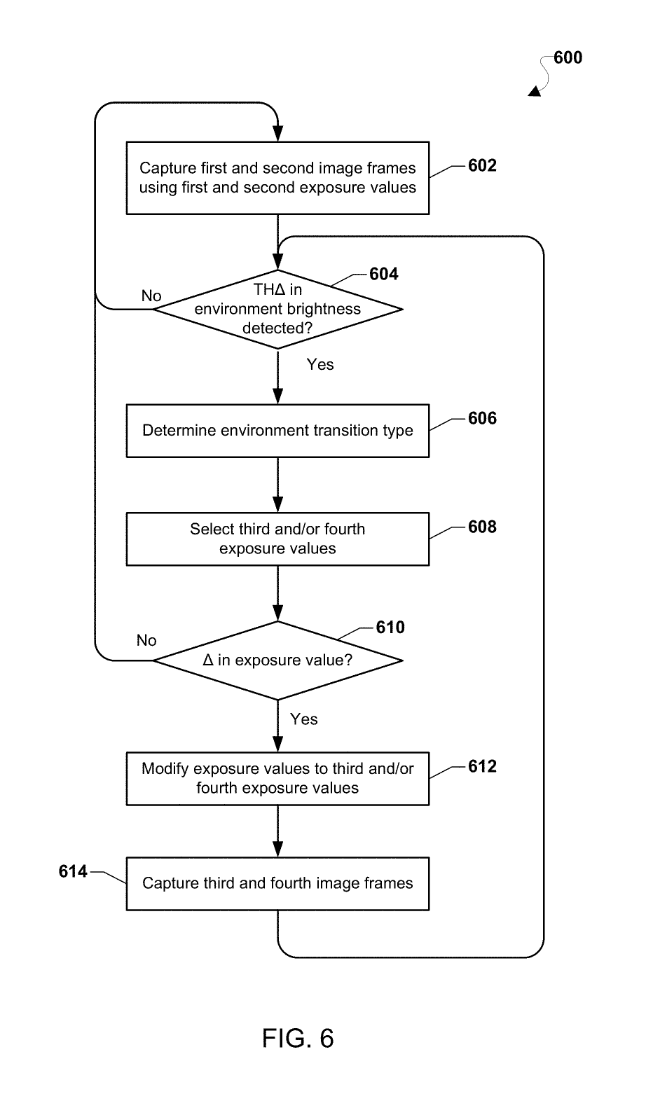

FIG. 6 illustrates a method 600 of modifying an exposure setting for a camera used to capture images used in navigating a robotic vehicle according to various embodiments. With reference to FIGS. 1-6, the method 600 may be implemented by one or more processors (e.g., processor 120, 208 and/or the like) of the robotic vehicle (e.g., 101) exchanging data and control commands with an image capture system (e.g., 140) that may include one or more cameras (e.g., 140a, 140b, 202a, 202b).

In block 602, the processor may cause the one or more cameras of an image capture system to capture the first and second image frames using the first and second exposure settings. The one or more cameras may continue to capture image frames using the first and second exposure settings.

The processor may continuously or periodically monitor the environment surrounding the robotic vehicle to determine brightness values within the environment. The brightness values may be determined based on measurements provided by the environment detection system (e.g., 218), using images captured by the image capture system, and/or measurements provided by the IMU (e.g., 216). In some examples, when images captured by the image capture system are used, the processor may generate a histogram of an image and determine brightness values of the environment surrounding the robotic vehicle based on the tonal distribution depicted in the histogram.

In determination block 604, the processor may determine whether a change in brightness values (THA) used to establish the first and second exposure settings and the brightness values determined based on measurements provided by the environment detection system, using images captured by the c image capture system, and/or measurements provided by the IMU exceeds a threshold variance. That is, the processor may compare the absolute value of the difference between the brightness values used to establish the first and exposure settings and the determined brightness values to determine whether it exceeds a predetermined value or range stored in memory (e.g., 210).

In response to determining that the change in brightness values does not exceed a threshold variance (i.e., determination block 604=“No”), the one or more cameras of the image capture system may continue to capture the first and second image frames using the first and second exposure settings, respectively.

In response to determining that the change in brightness values exceeds the threshold variance (i.e., determination block 604=“Yes”), the processor may determine a type of environment transition in block 606. For example, the processor may determine whether the brightness of the environment is transitioning from brighter values (i.e., outside) to darker values (i.e., inside) or from darker values to brighter values. In addition, the processor may determine whether the robotic vehicle is within a tunnel or at a transition point between inside and outside. The processor may determine the type of environment transition based on one or more of a determined brightness value, measurements provided by the IMU, measurements provided by the environment detection system, time, date, weather conditions, and location.

In block 608, the processor may select a third setting and/or a fourth exposure setting based on the type of environment transition. In some embodiments, predetermined exposure settings may be mapped to the different types of environment transitions. Alternatively, the processor may dynamically calculate the third and/or fourth exposure settings based on the determined brightness values.

In determination block 610, the processor may determine whether the third and/or fourth exposure settings are different from the first and/or second exposure settings. In response to determining that the third and fourth exposure settings are equal to the first and second exposure settings (i.e., determination block 610=“No”), the processor continues to capture image frames using the first and second exposure settings in block 602.

In response to determining that at least one of the third and fourth exposure settings are different from the first and/or second exposure settings (i.e., determination block 610=“Yes”), the processor may modify the exposure setting of the one or more cameras of the image capture system to the third and/or fourth exposure settings in block 612. If only one of the first and second exposure settings is different from the third or fourth values, the processor may instruct the camera to modify exposure setting that is different while instructing the camera to maintain the exposure setting that is the same.

In block 614, the processor may instruct the one or more cameras of the image capture system to capture the third and fourth image frames using the third and/or fourth exposure settings.

The method 600 may be performed continuously as the robotic vehicle moves through the environment, thereby enabling the exposure settings to be adjusted dynamically as different brightness levels are encountered. In some embodiments, when a plurality of cameras is implemented, the exposure settings may be assigned to the cameras in a prioritized fashion. For example, a first camera may be identified as the primary camera such that the exposure setting allows the primary camera to be considered the dominant camera and a second camera may be identified as the secondary camera that captures images using an exposure setting that supplements the primary camera.

In some embodiments, the first camera may be the primary camera in one (e.g., a first) environment and the secondary camera in another (e.g., a second) environment. For example, when the robotic vehicle is transitioning from a dim environment (e.g., inside a building, tunnel, or the like) to bright environment (e.g., outside), the exposure setting for the first camera may be optimized for image capture in the dim environment and the exposure setting for the second camera may be optimized to supplement image capture in the dim environment. As the robotic vehicle reaches a transition threshold between the dim environment and the bright environment (e.g., at a door way), the exposure setting for the second camera may be optimized for image capture in the bright environment and the exposure setting for the first camera may be optimized to supplement image capture in the bright environment. As another example, one camera may be configured as the primary camera when the robotic vehicle is operating at night, while the other camera may be configured as the primary camera when the vehicle is operating during daylight. The two (or more) cameras may have different light sensitivity or dynamic range, and the selection of the camera to be the primary camera in a given light environment may be based in part upon the imaging capabilities and dynamic ranges of the different cameras.

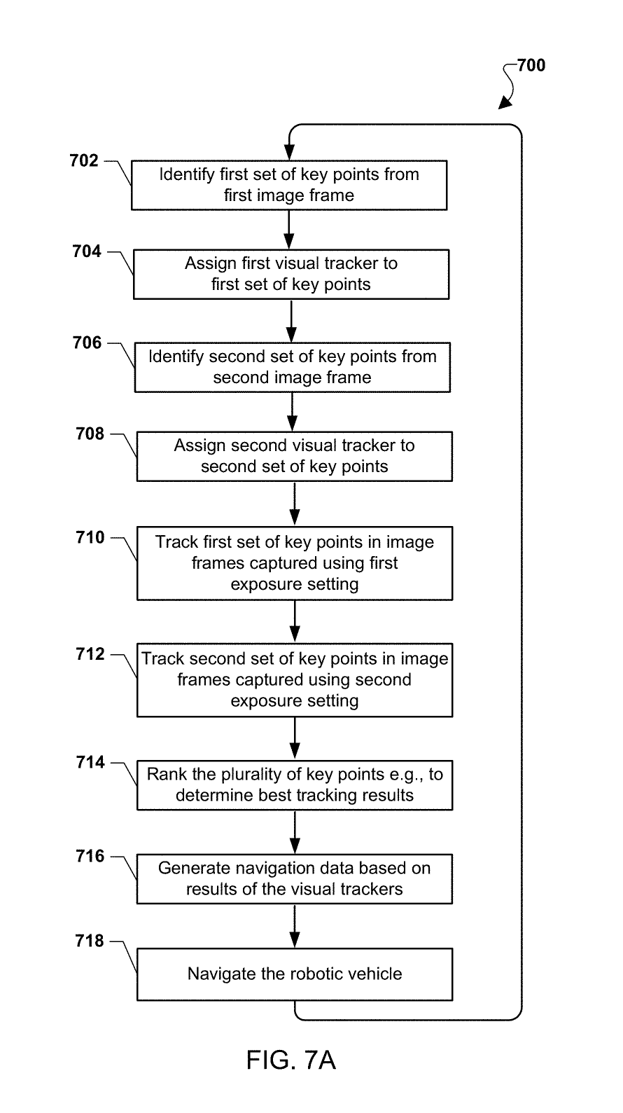

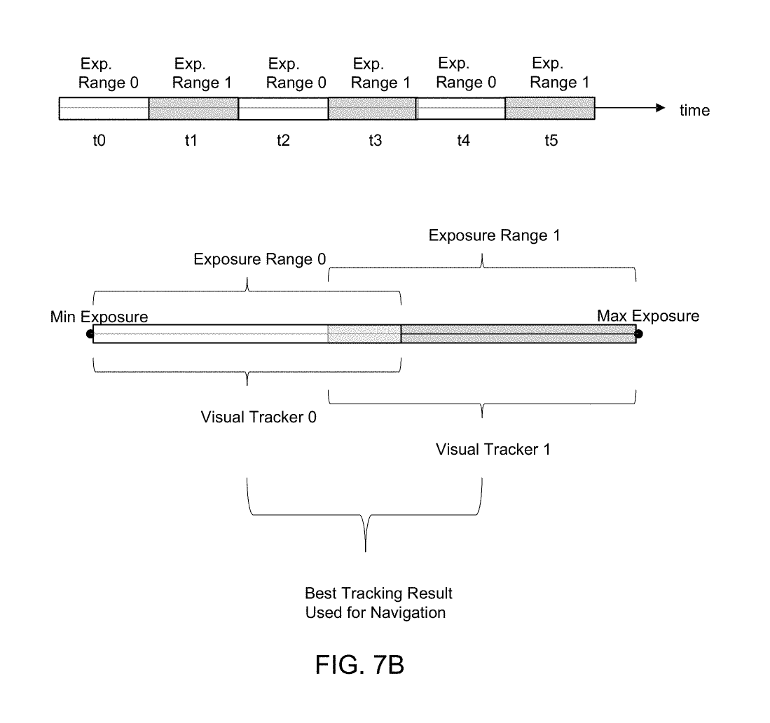

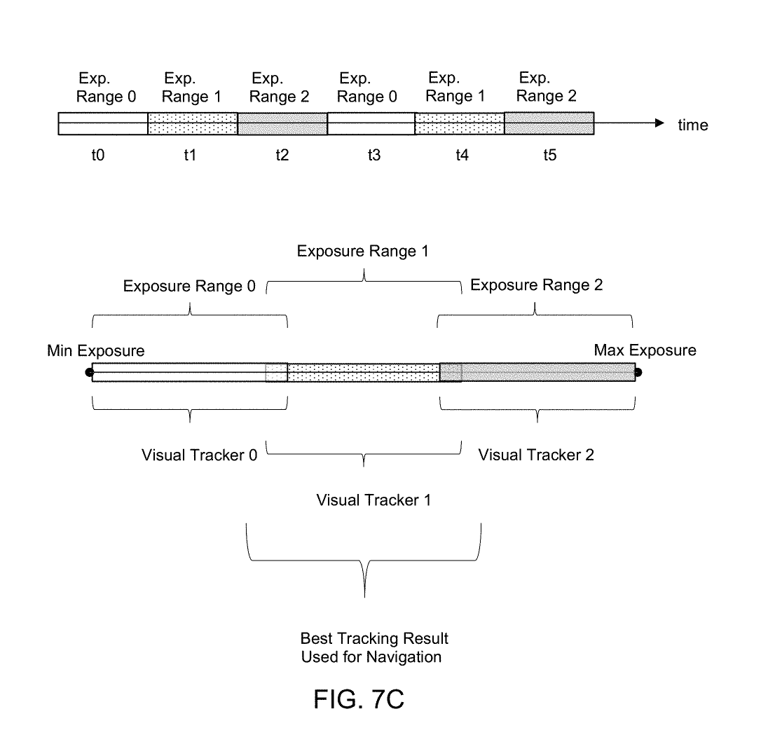

FIG. 7A illustrates a method 700 for navigating a robotic vehicle (e.g., robotic vehicle 101 or 200) according to various embodiments. With reference to FIGS. 1-7A, the method 700 may be implemented by one or more processors (e.g., processor 120, 208 and/or the like) exchanging data and control commands with an image capture system (e.g., 140) that may include one or more cameras (e.g., 140a, 140b, 202a, 202b) of the robotic vehicle (e.g., 101) within an environment according to various embodiments.

In block 702, the processor may identify a first set of key points from a first image frame captured using a first exposure setting. The first set of key points may correspond to or one or more distinctive pixel patches or regions within the image frame that include high contrast pixels or contrast points.

In block 704, the processor may assign a first visual tracker or VO instance to the first set of key points. The first tracker may be assigned to one or more sets of key points identified from the image frame captured at the first exposure setting.

In block 706, the processor may identify a second set of key points from a second image frame captured using a second exposure setting. The second set of key points may correspond to or one or more distinctive pixel patches or regions within the image frame that include high contrast pixels or contrast points.

In block 708, the processor may assign a second visual tracker or VO instance to the second set of key points. The second tracker may be assigned to one or more sets of key points identified from the image frame captured at the second exposure setting.

In block 710, the processor may track the first set of key points within image frames captured using the first exposure setting using the first visual tracker. In block 712, the processor may track the second set of key points within image frames captured using the second exposure setting using the second visual tracker.

In block 714, the processor may rank the plurality of key points, such as to determine a best tracking result for one or more key points included in the first set and/or the second set of key points. Such a ranking may be based on the results of the first visual tracker and the second visual tracker. For example, the processor may combine the tracking results from the first visual tracker and the second visual tracker. In some embodiments, the processor may determine the best tracking results by selecting the most key points that have the lowest covariance.

In block 716, the processor may generate navigation data based on the results of the first visual tracker and the second visual tracker.

In block 718, the processor may generate instructions to navigate the robotic vehicle using the generated navigation data. The operations of the method 700 may be performed repeatedly or continuously while navigating the robotic vehicle.

Examples of time and dynamic ranges that correspond to the method 700 are illustrated in FIGS. 7B and 7C. Referring to FIG. 7B, the method 700 includes running two exposure algorithms using different exposure algorithms: “Exp. Range 0” and “Exp. Range 1”. One or two cameras may be configured to implement the two different exposure algorithms in an interleaved fashion such that image frames corresponding to a first exposure setting included in the “Exp. Range 0” algorithm are captured at times t₀, t₂, and t₄ and the image frames corresponding to a second exposure setting included in the “Exp. Range 1” algorithm are captured at times t₁, t₃, and t₅.

FIG. 7B further illustrates the exposure ranges corresponding to the respective exposure algorithms and the visual trackers that correspond to the exposure algorithms with respect to the dynamic range of the environment of the robotic vehicle. In the illustrated example, a first visual tracker “Visual Tracker 0” is assigned to the key points identified from an image frame captured using an exposure setting included in the “Exp. Range 0” algorithm and a second visual tracker “Visual Tracker 1” is assigned to the key points identified from an image frame captured using an exposure setting included in the “Exp. Range 1” algorithm. In the example illustrated in FIG. 7B, an exposure range of the exposure setting included in the “Exp. Range 0” algorithm is selected to encompass a region of the dynamic range including lower brightness values. Specifically, the exposure range included in the “Exp. Range 0” algorithm may range from the minimum exposure value through middle brightness values of the dynamic range. An exposure range of the exposure setting included in the “Exp. Range 1” algorithm is selected to encompass a region of the dynamic range including the higher brightness values. Specifically, the exposure range included in the “Exp. Range 1” algorithm may range from middle brightness values through the maximum exposure value of the dynamic range.

The exposure ranges corresponding to the “Exp. Range 0” and the “Exp. Range 1” algorithms may be selected such that a portion of the ranges overlap within the middle brightness values of the dynamic range. In some embodiments, the overlap may create multiple key points for the same object in the environment. Due to the different exposure settings, various details and features corresponding to an object may be captured differently between an image frame captured using the “Exp. Range 0” algorithm and an image frame captured using the “Exp. Range 1” algorithm. For example, referring to FIG. 4C, key points associated with the chair in the center foreground of image frames 414 and 416 may be different. One or more key points included in a region of the image frame associated with the chair identified from image frame 416 may include more key points than the one or more key points included in the same region and identified from image frame 414 because the complementary exposure setting allows for greater contrast enabling key points associated with the details of the chair (i.e., seams along the edge, contour of the headrest, etc.) to be identified from image frame 416 that are not present in the image frame 414.

Referring back to FIG. 7B, in some embodiments, the tracking results of the first visual tracker and the second visual tracker may be used to determine the best tracking result. For example, a filtering technique may be applied to the tracking results of the first visual tracker and the second visual tracker. Alternatively or in addition, the tracking results of the first visual tracker and the second visual tracker may be merged to determine the best tracking result. The best tracking result may be used to generate navigational instructions for the robotic vehicle in block 716 of the method 700.

FIG. 7C illustrates an implementation in which the method 700 includes three exposure algorithms using different exposure algorithms: “Exp. Range 0”, “Exp. Range 1”, and “Exp. Range 2”. One, two, or three cameras may be configured to implement the three different exposure algorithms in an interleaved fashion such that image frames corresponding to a first exposure setting included in the “Exp. Range 0” algorithm are captured at times t₀, and t₃, the image frames corresponding to a second exposure setting included in the “Exp. Range 1” algorithm are captured at times t₁ and t₄, and the image frames corresponding to a third exposure setting included in the “Exp. Range 2” algorithm are captured at times t₂ and t₅.

FIG. 7C further illustrates the exposure ranges corresponding to the respective exposure algorithms and the visual trackers that correspond to the exposure algorithms with respect to the dynamic range of the environment of the robotic vehicle. In the illustrated example, a first visual tracker “Visual Tracker 0” is assigned to the key points identified from an image frame captured using an exposure setting included in the “Exp. Range 0” algorithm, a second visual tracker “Visual Tracker 1” is assigned to the key points identified from an image frame captured using an exposure setting included in the “Exp. Range 1” algorithm, and a third visual tracker “Visual Tracker 2” is assigned to the key points identified from an image frame captured using an exposure setting included in the “Exp. Range 2” algorithm. In the example illustrated in FIG. 7B, an exposure range of the exposure setting included in the “Exp. Range 1” algorithm is selected to encompass the middle brightness values and to overlap a portion of the exposure range included in the “Exp. Range 0” algorithm and a portion of the exposure range included in the “Exp. Range 2” algorithm. The best tracking result used for navigation is then determined from the results of the first visual tracker, the second visual tracker, and the third visual tracker.

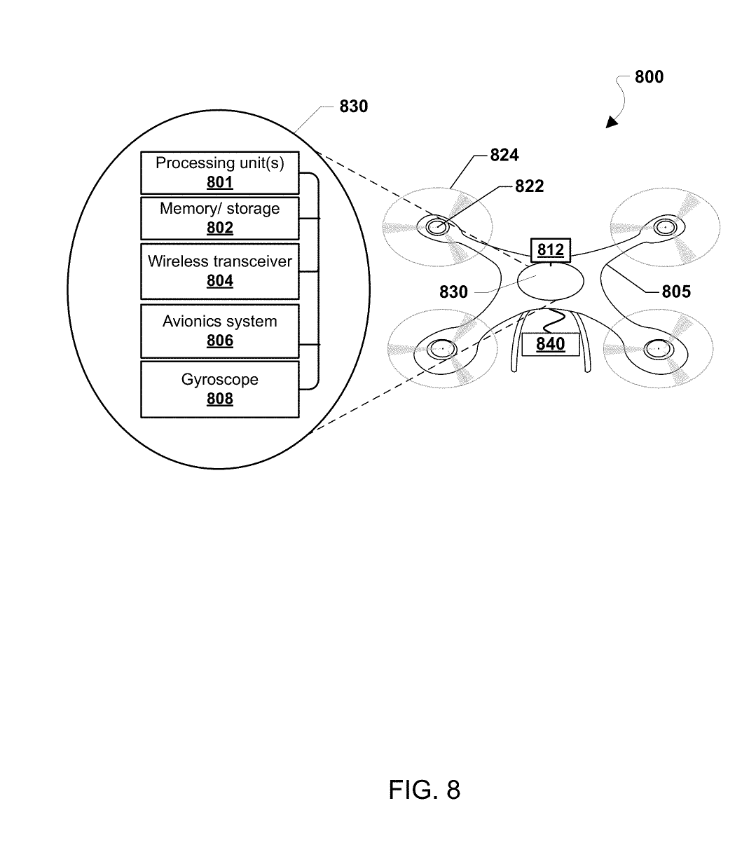

Various embodiments may be implemented in a variety of drones configured with an image capture system (e.g., 140) including a camera, an example of which is a four-rotor drone illustrated in FIG. 8. With reference to FIGS. 1-8, a drone 800 may include a body 805 (i.e., fuselage, frame, etc.) that may be made out of any combination of plastic, metal, or other materials suitable for flight. For ease of description and illustration, some detailed aspects of the drone 800 are omitted, such as wiring, frame structure, power source, landing columns/gear, or other features that would be known to one of skill in the art. In addition, although the example drone 800 is illustrated as a “quad-copter” with four rotors, the one or more of drones 800 and may include more or fewer than four rotors. Also, the one or more of drones 800 may have similar or different configurations, numbers of rotors, and/or other aspects. Various embodiments may also be implemented with other types of drones, including other types of autonomous aircraft, land vehicles, waterborne vehicles, or a combination thereof.

The body 805 may include a processor 830 that is configured to monitor and control the various functionalities, subsystems, and/or other components of the drone 800. For example, the processor 830 may be configured to monitor and control any combination of modules, software, instructions, circuitry, hardware, etc. related to camera calibration as described, as well as propulsion, navigation, power management, sensor management, and/or stability management.

The processor 830 may include one or more processing unit(s) 801, such as one or more processors configured to execute processor-executable instructions (e.g., applications, routines, scripts, instruction sets, etc.) to control flight and other operations of the drone 800, including operations of various embodiments. The processor 830 may be coupled to a memory unit 802 configured to store data (e.g., flight plans, obtained sensor data, received messages, applications, etc.). The processor may also be coupled to a wireless transceiver 804 configured to communicate via wireless communication links with ground stations and/or other drones.

The processor 830 may also include an avionics module or system 806 configured to receive inputs from various sensors, such as a gyroscope 808, and provide attitude and velocity information to a processing unit 801.

In various embodiments, the processor 830 may be coupled to a camera 840 configured to perform operations of various embodiments as described. In some embodiments, the drone processor 830 may receive image frames from the camera 840 and rotation rate and direction information from the gyroscope 808, and perform operations as described. In some embodiments, the camera 840 may include a separate gyroscope (not shown) and a processor (not shown) configured to perform operations as described.

Drones may be winged or rotor craft varieties. For example, the drone 800 may be a rotary propulsion design that utilizes one or more rotors 824 driven by corresponding motors 822 to provide lift-off (or take-off) as well as other aerial movements (e.g., forward progression, ascension, descending, lateral movements, tilting, rotating, etc.). The drone 800 is illustrated as an example of a drone that may utilize various embodiments, but is not intended to imply or require that various embodiments are limited to rotor craft drones. Instead, various embodiments may be implemented on winged drones as well. Further, various embodiments may equally be used with land-based autonomous vehicles, water-borne autonomous vehicles, and space-based autonomous vehicles.

A rotor craft drone 800 may utilize motors 822 and corresponding rotors 824 for lifting off and providing aerial propulsion. For example, the drone 800 may be a quad-copter” that is equipped with four motors 822 and corresponding rotors 824. The motors 822 may be coupled to the processor 830 and thus may be configured to receive operating instructions or signals from the processor 830. For example, the motors 822 may be configured to increase rotation speed of their corresponding rotors 824, etc. based on instructions received from the processor 830. In some embodiments, the motors 822 may be independently controlled by the processor 830 such that some rotors 824 may be engaged at different speeds, using different amounts of power, and/or providing different levels of output for moving the drone 800.

The body 805 may include a power source 812 that may be coupled to and configured to power the various components of the drone 800. For example, the power source 812 may be a rechargeable battery for providing power to operate the motors 822, the camera 840, and/or the units of the processor 830.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300 and 400 may be substituted for or combined with one or more operations of the methods 300 and 400, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. For example, operations to predict locations of objects in a next image frame may be performed before, during or after the next image frame is obtained, and measurements of rotational velocity by a gyroscope may be obtained at any time or continuously during the methods.

Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular. Further, the words “first” and “second” are merely for purposes of clarifying references to particular elements, and are not intended to limit a number of such elements or specify an ordering of such elements.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of navigating a robotic vehicle within an environment, comprising:
receiving a first image frame captured using a first exposure setting;
receiving a second image frame captured using a second exposure setting different from the first exposure setting;
identifying a plurality of points from the first image frame and the second image frame;
assigning a first visual tracker to a first set of the plurality of points identified from the first image frame and a second visual tracker to a second set of the plurality of points identified from the second image frame;
generating navigation data based on results of the first visual tracker and the second visual tracker; and
controlling the robotic vehicle to navigate within the environment using the navigation data.

2. The method of claim 1, wherein identifying the plurality of points from the first image frame and the second image frame comprises:
identifying a plurality of points from the first image frame;
identifying a plurality of points from the second image frame;
ranking the plurality of points; and
selecting one or more identified points for use in generating the navigation data based on the ranking of the plurality of points object.

3. The method of claim 1, wherein generating navigation data based on the results of the first visual tracker and the second visual tracker comprises:
tracking the first set of the plurality of points between image frames captured using the first exposure setting with the first visual tracker;
tracking the second set of the plurality of points between image frames captured using the second exposure setting with the second visual tracker;
estimating a location of one or more of the identified plurality of points within a three-dimensional space; and
generating the navigation data based on the estimated location of the one or more of the identified plurality of points within the three-dimensional space.

4. The method of claim 1, further comprising using two or more cameras to capture image frames using the first exposure setting and the second exposure setting.

5. The method of claim 1, further comprising using a single camera to sequentially capture image frames using the first exposure setting and the second exposure setting.

6. The method of claim 1, wherein the first exposure setting complements the second exposure setting.

7. The method of claim 1, wherein at least one of the points identified from the first image frame is different from at least one of the points identified from the second image frame.

8. The method of claim 1, further comprising determining the exposure setting for a camera used to capture the second image frame by:
determining whether a change in a brightness value associated with the environment exceeds a predetermined threshold;
determining an environment transition type in response to determining that the change in the brightness value associated with the environment exceeds the predetermined threshold; and
determining the second exposure setting based on the determined environment transition type.

9. The method of claim 8, wherein determining whether the change in the brightness value associated with the environment exceeds the predetermined threshold is based on at least one of a measurement detected by an environment detection system, an image frame captured using the camera, and a measurement provided by an inertial measurement unit.

10. The method of claim 1, further comprising:
determining a dynamic range associated with the environment;
determining a brightness value within the dynamic range;
determining a first exposure range for a first exposure algorithm by ignoring the brightness value; and
determining a second exposure range for second exposure algorithm based on only the brightness value,
wherein the first exposure setting is based on the first exposure range and the second exposure setting is based on the second exposure range.

11. A robotic vehicle, comprising:
an image capture system; and
a processor coupled to the image capture system and configured with processor-executable instructions to:
receive a first image frame captured by the image capture system using a first exposure setting;
receive a second image frame captured by the image capture system using a second exposure setting different from the first exposure setting;
identify a plurality of points from the first image frame and the second image frame;
assign a first visual tracker to a first set of the plurality of points identified from the first image frame and a second visual tracker to a second set of the plurality of points identified from the second image frame;
generate navigation data based on results of the first visual tracker and the second visual tracker; and
control the robotic vehicle to navigate within the environment using the navigation data.

12. The robotic vehicle of claim 11, wherein the processor is further configured to identify the plurality of points from the first image frame and the second image frame by:
identifying a plurality of points from the first image frame;
identifying a plurality of points from the second image frame;
ranking the plurality of points; and
selecting one or more identified points for use in generating the navigation data based on the ranking of the plurality of points.

13. The robotic vehicle of claim 11, wherein the processor is further configured to generate navigation data based on the results of the first visual tracker and the second visual tracker by:
tracking the first set of the plurality of points between image frames captured using the first exposure setting with the first visual tracker;
tracking the second set of the plurality of points between image frames captured using the second exposure setting with the second visual tracker;
estimating a location of one or more of the identified plurality of points within a three-dimensional space; and
generating the navigation data based on the estimated location of the one or more of the identified plurality of points within the three-dimensional space.

14. The robotic vehicle of claim 11, wherein the image capture system comprises two or more cameras configured to capture image frames using the first exposure setting and the second exposure setting.

15. The robotic vehicle of claim 11, wherein the image capture system comprises a single camera configured to sequentially capture image frames using the first exposure setting and the second exposure setting.

16. The robotic vehicle of claim 11, wherein the first exposure setting complements the second exposure setting.

17. The robotic vehicle of claim 11, wherein the processor is further configured to determine the second exposure setting for a camera of the image capture system used to capture the second image frame by:
determining whether a change in a brightness value associated with the environment exceeds a predetermined threshold;
determining an environment transition type in response to determining that the change in the brightness value associated with the environment exceeds the predetermined threshold; and
determining the second exposure setting based on the determined environment transition type.

18. The robotic vehicle of claim 17, wherein the processor is further configured to determine whether the change in the brightness value associated with the environment exceeds the predetermine threshold based on at least one of a measurement detected by an environment detection system, an image frame captured using the camera, and a measurement provided by an inertial measurement unit.

19. The robotic vehicle of claim 11, wherein the processor is further configured to:
determine a dynamic range associated with the environment;
determine a brightness value within the dynamic range;
determine a first exposure range for a first exposure algorithm by ignoring the brightness value; and
determine a second exposure range for second exposure algorithm based on only the brightness value,
wherein the first exposure setting is based on the first exposure range and the second exposure setting is based on the second exposure range.

20. A processor for use in a robotic vehicle, wherein the processor is configured to:
receive a first image frame captured by an image capture system using a first exposure setting;
receive a second image frame captured by the image capture system using a second exposure setting different from the first exposure setting;
identify a plurality of points from the first image frame and the second image frame;
assign a first visual tracker to a first set of the plurality of points identified from the first image frame and a second visual tracker to a second set of the plurality of points identified from the second image frame;
generate navigation data based on results of the first visual tracker and the second visual tracker; and
control the robotic vehicle to navigate within the environment using the navigation data.

21. The processor of claim 20, wherein the processor is further configured to identify the plurality of points from the first image frame and the second image frame by:
identifying a plurality of points from the first image frame;
identifying a plurality of points from the second image frame;
ranking the plurality of points; and
selecting one or more identified points for use in generating the navigation data based on the ranking of the plurality of points.

22. The processor of claim 20, wherein the processor is further configured to generate navigation data based on the results of the first visual tracker and the second visual tracker by:
tracking the first set of the plurality of points between image frames captured using the first exposure setting with the first visual tracker;
tracking the second set of the plurality of points between image frames captured using the second exposure setting with the second visual tracker;
estimating a location of one or more of the identified plurality of points within a three-dimensional space; and
generating the navigation data based on the estimated location of the one or more of the identified plurality of points within the three-dimensional space.

23. The processor of claim 20, wherein the first and second images are received from two or more cameras configured to capture image frames using the first exposure setting and the second exposure setting.

24. The processor of claim 20, wherein the first and second images are received from a single camera configured to sequentially capture image frames using the first exposure setting and the second exposure setting.

25. The processor of claim 20, wherein the first exposure setting complements the second exposure setting.

26. The processor of claim 20, wherein the processor is further configured to determine the second exposure setting for a camera used to capture the second image frame by:
determining whether a change in a brightness value associated with the environment exceeds a predetermined threshold;
determining an environment transition type in response to determining that the change in the brightness value associated with the environment exceeds the predetermined threshold; and
determining the second exposure setting based on the determined environment transition type.

27. The processor of claim 26, wherein the processor is further configured to determine whether the change in the brightness value associated with the environment exceeds the predetermine threshold based on at least one of a measurement detected by an environment detection system, an image frame captured using the camera, and a measurement provided by an inertial measurement unit.

28. The processor of claim 20, wherein the processor is further configured to:
determine a dynamic range associated with the environment;
determine a brightness value within the dynamic range;
determine a first exposure range for a first exposure algorithm by ignoring the brightness value; and
determine a second exposure range for second exposure algorithm based on only the brightness value,
wherein the first exposure setting is based on the first exposure range and the second exposure setting is based on the second exposure range.

29. A non-transitory, processor-readable medium having stored thereon processor-executable instructions configured to cause a processor of a robotic vehicle to perform operations comprising:
receiving a first image frame captured using a first exposure setting;
receiving a second image frame captured using a second exposure setting different from the first exposure setting;
identifying a plurality of points from the first image frame and the second image frame;
assigning a first visual tracker to a first set of the plurality of points identified from the first image frame and a second visual tracker to a second set of the plurality of points identified from the second image frame;
generating navigation data based on results of the first visual tracker and the second visual tracker; and
controlling the robotic vehicle to navigate within the environment using the navigation data.

30. The non-transitory, processor-readable medium of claim 29, wherein the stored processor-executable instructions are configured to cause a processor of a robotic vehicle to perform operations such that generating navigation data based on the results of the first visual tracker and the second visual tracker comprises:
tracking the first set of the plurality of points between image frames captured using the first exposure setting with the first visual tracker;
tracking the second set of the plurality of points between image frames captured using the second exposure setting with the second visual tracker;
estimating a location of one or more of the identified plurality of points within a three-dimensional space; and
generating the navigation data based on the estimated location of the one or more of the identified plurality of points within the three-dimensional space.
